(19) United States
(12) Patent Application Publication
(10) Pub. No.: US 2026/0122678 A1
(43) Pub. Date: Apr. 30, 2026

(54) CARRIER FREQUENCY OFFSET COMPENSATION BETWEEN ACCESS POINTS FOR COORDINATED BEAMFORMING SOUNDING AND TRANSMISSION

(71) Applicant: QUALCOMM Incorporated, San Diego, CA (US)

(72) Inventors: Sherief HELWA, San Diego, CA (US); George CHERIAN, San Diego, CA (US); Youhan KIM, Saratoga, CA (US); Abhishek Pramod PATIL, San Diego, CA (US); Alfred ASTERJADHI, San Diego, CA (US); Gaurang NAIK, San Diego, CA (US); Giovanni CHISCI, San Diego, CA (US); Sanket Sanjay KALAMKAR, San Diego, CA (US); Sai Yiu Duncan HO, San Diego, CA (US); Ahmed Ragab ELSHERIF, San Jose, CA (US)

(21) Appl. No.: 18/932,590

(22) Filed: Oct. 30, 2024

(51) Int. Cl. H04W 74/0816; H04B 7/06; H04W 74/08

(52) U.S. Cl. CPC H04W 74/0816; H04B 7/0617; H04W 74/0891

(57) ABSTRACT

This disclosure provides methods, components, devices and systems for carrier frequency offset compensation between access points for coordinated beamforming sounding and transmission. During a channel sounding phase of a CBF operation, a first AP acting as a frequency reference may transmit a frequency reference frame. A second AP may use the frequency reference frame to estimate a CFO and pre-compensate for the CFO for subsequent transmissions during the channel sounding phase and during a transmission phase of the CBF operation. In some examples, the first AP may own a shared TXOP of the transmission phase. The second AP may receive a frequency reference frame for estimating the CFO. In some other examples, the second AP may own the shared TXOP. The second AP may request the first AP to transmit the frequency reference frame. Alternatively, the second AP may use a CFO value estimated during the channel sounding phase.

### TECHNICAL FIELD

This disclosure relates generally to wireless communication and, more specifically, to carrier frequency offset compensation between access points for coordinated beamforming sounding and transmission.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a first access point (AP) is described. The method may include communicating one or more control messages with a second AP to trigger a coordinated beamforming (CBF) sounding procedure by the first AP and the second AP, the one or more control messages indicating that the second AP is to operate as a carrier frequency alignment reference for messaging of the CBF sounding procedure, receiving a frequency reference frame from the second AP, and transmitting one or more sounding messages of the CBF sounding procedure based on a carrier frequency offset (CFO) estimated from the frequency reference frame.

A first AP for wireless communications is described. The first AP may include a processing system that includes processor circuitry and memory circuitry that stores code. The processing system may be configured to cause the first AP to communicate one or more control messages with a second AP to trigger a CBF sounding procedure by the first AP and the second AP, the one or more control messages indicating that the second AP is to operate as a carrier frequency alignment reference for messaging of the CBF sounding procedure, receive a frequency reference frame from the second AP, and transmit one or more sounding messages of the CBF sounding procedure based on a CFO estimated from the frequency reference frame.

Another first AP for wireless communications is described. The first AP may include means for communicating one or more control messages with a second AP to trigger a CBF sounding procedure by the first AP and the second AP, the one or more control messages indicating that the second AP is to operate as a carrier frequency alignment reference for messaging of the CBF sounding procedure, means for receiving a frequency reference frame from the second AP, and means for transmitting one or more sounding messages of the CBF sounding procedure based on a CFO estimated from the frequency reference frame.

A non-transitory computer-readable medium storing code for wireless communications is described. The code may include instructions executable by one or more processors to communicate one or more control messages with a second AP to trigger a CBF sounding procedure by the first AP and the second AP, the one or more control messages indicating that the second AP is to operate as a carrier frequency alignment reference for messaging of the CBF sounding procedure, receive a frequency reference frame from the second AP, and transmit one or more sounding messages of the CBF sounding procedure based on a CFO estimated from the frequency reference frame.

Some examples of the method, first APs, and non-transitory computer-readable medium described herein may further include operations, features, means, or instructions for receiving a synchronization frame that acts as a second frequency reference frame from the second AP for a second CBF sounding procedure and transmitting one or more sounding messages of the second CBF sounding procedure based on the synchronization frame.

Some examples of the method, first APs, and non-transitory computer-readable medium described herein may further include operations, features, means, or instructions for transmitting an initial control frame (ICF) to the second AP for a second CBF sounding procedure, receiving an initial control response (ICR) frame that acts as a second frequency reference frame from the second AP for the second CBF sounding procedure, and transmit one or more sounding messages of the second CBF sounding procedure based on a second CFO estimated from the ICR frame.

In some examples of the method, first APs, and non-transitory computer-readable medium described herein, the one or more control messages indicate whether additional CBF sounding procedures may be performed sequentially or simultaneously by the first AP and the second AP.

In some examples of the method, first APs, and non-transitory computer-readable medium described herein, the frequency reference frame may be a null data packet announcement (NDPA) frame.

In some examples of the method, first APs, and non-transitory computer-readable medium described herein, communicating the one or more control messages may include operations, features, means, or instructions for receiving a first control message of the one or more control messages indicating that the second AP may be operating as the carrier frequency alignment reference.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports carrier frequency offset (CFO) compensation between access points (APs) for coordinated beamforming (CBF) sounding and transmission.

FIG. 3 shows an example of a signaling diagram that supports CFO compensation between APs for CBF sounding and transmission.

FIG. 4 shows an example of a signaling diagram that supports CFO compensation between APs for CBF sounding and transmission.

FIG. 5 shows an example of a signaling diagram that supports CFO compensation between APs for CBF sounding and transmission.

FIG. 6 shows an example of a signaling diagram that supports CFO compensation between APs for CBF sounding and transmission.

FIG. 7 shows an example of a signaling diagram that supports CFO compensation between APs for CBF sounding and transmission.

FIG. 8 shows an example of a signaling diagram that supports CFO compensation between APs for CBF sounding and transmission.

FIG. 9 shows an example of a signaling diagram that supports CFO compensation between APs for CBF sounding and transmission.

FIG. 10 shows an example of a process flow that supports CFO compensation between APs for CBF sounding and transmission.

FIG. 11 shows an example of a process flow that supports CFO compensation between APs for CBF sounding and transmission.

FIG. 12 shows an example of a process flow that supports CFO compensation between APs for CBF sounding and transmission.

FIG. 13 shows a block diagram of an example wireless communication device that supports CFO compensation between APs for CBF sounding and transmission.

FIGS. 14, 15, and 16 show flowcharts illustrating example processes performable by or at a first AP that supports CFO compensation between APs for CBF sounding and transmission.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support a coordinated beamforming (CBF) operation in which two or more access points (APs) simultaneously use the medium in two or more basic service sets (BSSs) to increase or maximize the system throughput (such as in an overlapping BSS (OBSS)). A CBF operation may include a channel sounding phase to make channel state information (CSI) available at each AP and a transmission phase, where the two or more APs agree on which client STAs will be served and synchronize transmissions within a shared transmission opportunity (TXOP). In some implementations, there may be a difference between the carrier frequencies of each AP, which may cause signal degradation if left uncorrected. Accordingly, one of the two or more APs may adjust a carrier frequency of the one AP in accordance with a second AP that is acting as a frequency reference such that the two APs are aligned in frequency. For example, the second AP may transmit a frequency reference frame for a first AP to estimate a carrier frequency offset (CFO) between the first AP and the second AP. In some examples, the two or more APs may perform CBF operations over multiple TXOPs, where each TXOP may be owned by one of the two or more APs. However, in some cases, the AP acting as a frequency reference may not own a given TXOP, which may impede an ability of the AP to transmit a frequency reference frame.

Various aspects relate generally to CFO alignment between APs for CBF sounding and CBF transmission procedures. Some aspects more specifically relate to CFO alignment during a sequential channel sounding procedure and CFO alignment during a joint channel sounding procedure. In some examples, during a channel sounding phase of a CBF operation, a first AP acting as a frequency reference may transmit a frame acting as a frequency reference frame. A second AP may detect the frequency reference frame and estimate a CFO between the first AP and the second AP. The second AP may pre-compensate for the CFO for all subsequent transmissions from the second AP during the channel sounding phase. In some examples, during a transmission phase of the CBF operation, the first AP acting as a frequency reference may also own the shared TXOP associated with the transmission phase, and the second AP may use signaling from the first AP initiating the CBF transmission procedure as a frequency reference frame for estimating the CFO. In some other examples, during the transmission phase of the CBF operation, the second AP may own the shared TXOP associated with the transmission phase, and the second AP may transmit signaling soliciting a frequency response frame from the first AP acting as the frequency reference. Alternatively, the second AP that owns the shared TXOP may use a stored CFO value estimated during the channel sounding phase for frequency pre-compensation.

Particular aspects of the subject matter described in this disclosure can be implemented to realize one or more of the following potential advantages. In some examples, by estimating a CFO using a frequency reference frame and pre-compensating upcoming transmissions with the estimated CFO, the described techniques can be used to perform CFO pre-compensation over multiple shared TXOPs, even in cases where the AP acting as a frequency reference is not an owner of a shared TXOP. Additionally, the described techniques may simplify PHY-layer operations, including CFO estimation and frequency compensation, in cases where the AP acting as a frequency reference is not an owner of a shared TXOP.

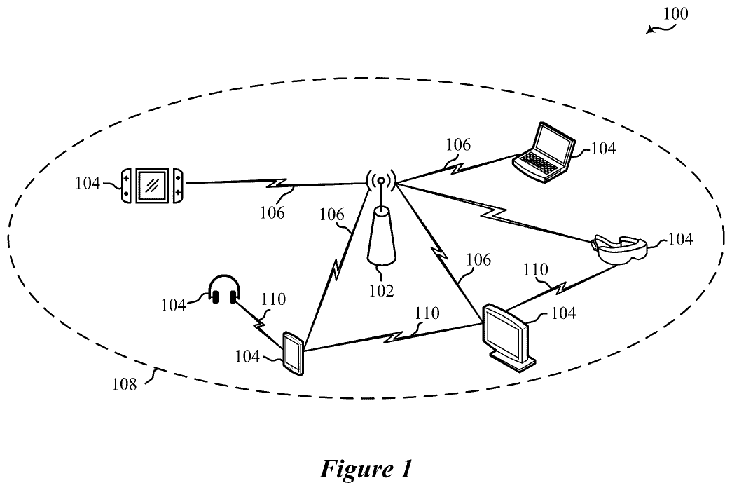

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz - 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product).

Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

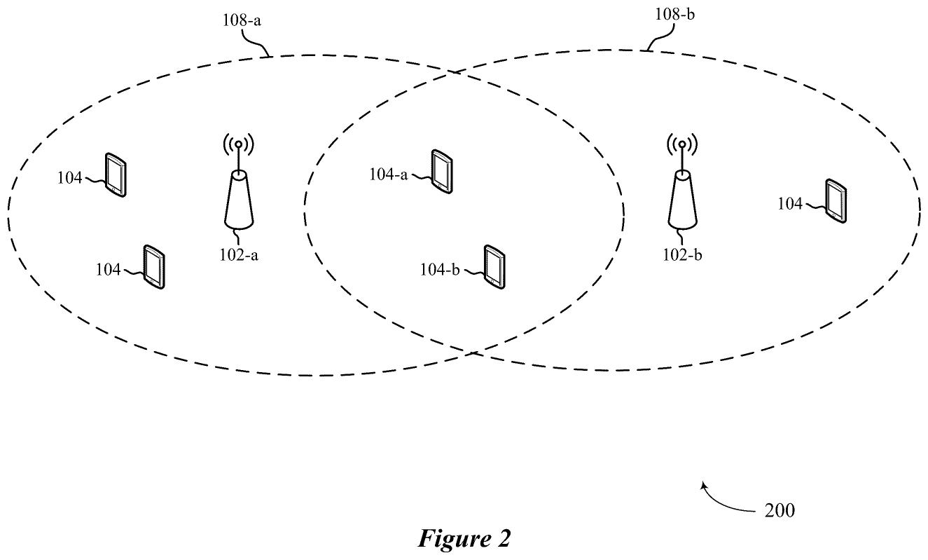

FIG. 2 shows an example of a signaling diagram 200 that supports CFO compensation between access points for coordinated beamforming sounding and transmission. In some examples, the signaling diagram 200 may implement or be implemented by aspects of the wireless communications network 100. For example, the signaling diagram 200 may include a first AP 102-a, a second AP 102-b, a first STA 104-a, a second STA 104-b, and one or more other STAs 104, which may be examples of corresponding devices described herein with reference to FIG. 1. Additionally, or alternatively, the APs 102 and the STAs 104 may each be examples of other types of wireless devices, such as a BS, a UE, or another type of transmitter or receiver. Thus, although aspects of the present disclosure are described with reference to APs 102 and STAs 104, it is understood that the described techniques may be performed by a wireless device different from an AP 102 and a STA 104. As described herein, operations performed by the APs 102 and the STAs 104 may be respectively performed by an AP 102, a STA 104, or another wireless device, and the examples shown should not be construed as limiting. Additionally, or alternatively, while two APs 102 and five STAs 104 are shown in the signaling diagram 200, more devices or fewer devices may be possible and the examples shown should not be construed as limiting.

Each of the first AP 102-a and the second AP 102-b may be associated with a respective BSS (e.g., a first BSS and a second BSS, respectively), where each BSS includes one or more STAs 104. For example, the first BSS may include one or more devices within a first coverage area 108-a (such as the AP 102-a, the STA 104-a, the STA 104-b, and one or more other STAs 104). Similarly, the second BSS may include one or more devices within a second coverage area 108-b (e.g., the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

In some examples, devices in the signaling diagram 200 may support one or more CBF operations. A CBF operation may be a coordinated AP scheme that aims at simultaneously using a medium (e.g., a wireless channel) in two or more BSSs to maximize the system throughput. In some examples, the CBF operation may exploit one or more hardware capabilities of the AP 102-a and the AP 102-b (e.g., larger antenna arrays) to actively null signals at one or more clients of the OBSS using transmission beamforming. For example, the first AP 102-a may create a null at the second STA 104-b associated with the second AP 102-b and the second BSS, and the second AP 102-b may create a null at the first STA 104-a associated with the first AP 102-a and the first BSS. In this way, OBSS interference may be limited and successful reception may be achieved. However, to perform such a CBF operation, transmitting devices (e.g., the first AP 102-a and the second AP 102-b) may have CSI knowledge (e.g., may know CSI information). For example, the AP 102-a may perform the CBF operation based on knowing the channel estimate between the AP 102-a and an associated client (e.g., STA 104) as well as between the AP 102-a and the OBSS client (e.g., the STA 104-a). The AP 102-a may be unable to perform the CBF operation without such channel estimates.

A CBF operation may be divided into two main phases: a channel sounding phase (e.g., CSI estimate collection) and a transmission phase (e.g., initial negotiation and initial handshaking between the first AP 102-a and the second AP 102-b in addition to data transmission). The objective of the channel sounding phase may be to make the CSI available at the OBSS APs 102 so that the OBSS AP 102 may actively null a signal at the OBSS client. For example, as a result of the channel sounding phase, the first AP 102-a may null an associated signal at the STA 104-b and the second AP 102-b may null an associated signal at the STA 104-a to reduce interference. During the transmission phase of the CBF operation, the first AP 102-a and the second AP 102-b (and any other APs 102 that may contribute to the OBSS) may agree on which clients (e.g., STAs 104) will be served by which AP 102, synchronize with each device, and proceed with simultaneous data transmission. During the simultaneous data transmission, the first AP 102-a and the second AP 102-b may use the CSI collected during the channel sounding phase in order to create the nulls in each respective signal.

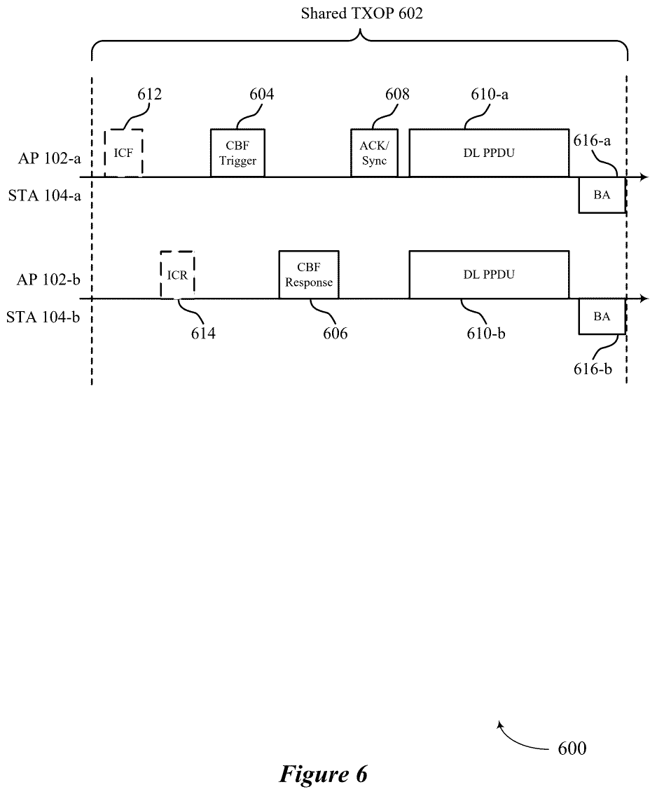

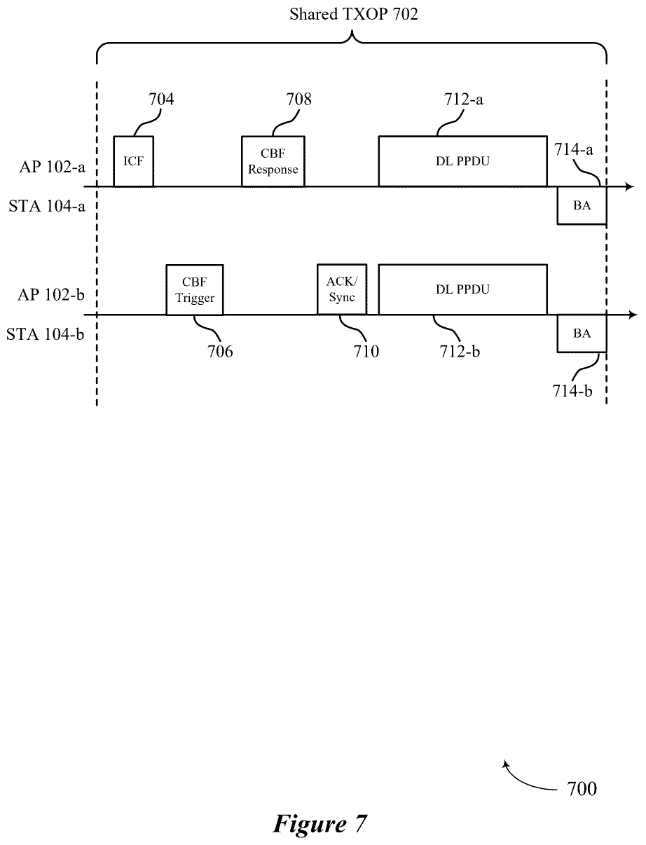

The channel sounding phase of the CBF operation may be a collaborative process performed by two or more APs 102 to collect CSI between each AP 102 and the OBSS clients (e.g., STAs 104). The general procedures of CBF channel sounding may follow the same concept of legacy in-BSS CBF channel sounding using the NDPA-NDP-BFRP-CSI frame sequence, as illustrated herein by at least FIGS. 6 and 7.

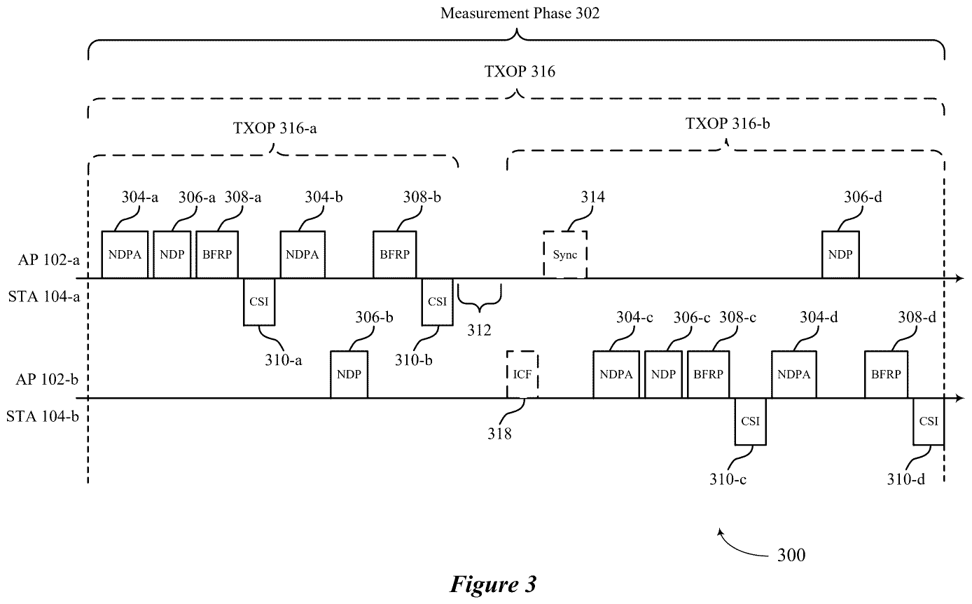

CBF channel sounding may be sequential or joint. In sequential channel sounding, sounding is first performed for an associated AP 102 (e.g., the first AP 102-a) by transmitting a null data packet (NDP) and receiving CSI in response to a beamforming report (BFRP) frame. Second sounding is performed for an OBSS AP 102 (e.g., the second AP 102-b). For example, the associated AP 102-a may transmit a null data packet announcement (NDPA) on behalf of the OBSS AP 102-b. The OBSS AP 102-b may transmit an NDP followed by a BFRP frame sent by the associated AP 102-a on behalf of the OBSS AP 102-b. Finally, the client (e.g., the AP 102) may report back associated CSI. The sequential sounding process may be repeated for all APs 102 participating in the channel sounding process. Additional details related to sequential channel sounding are described in further detail herein with reference to FIG. 3.

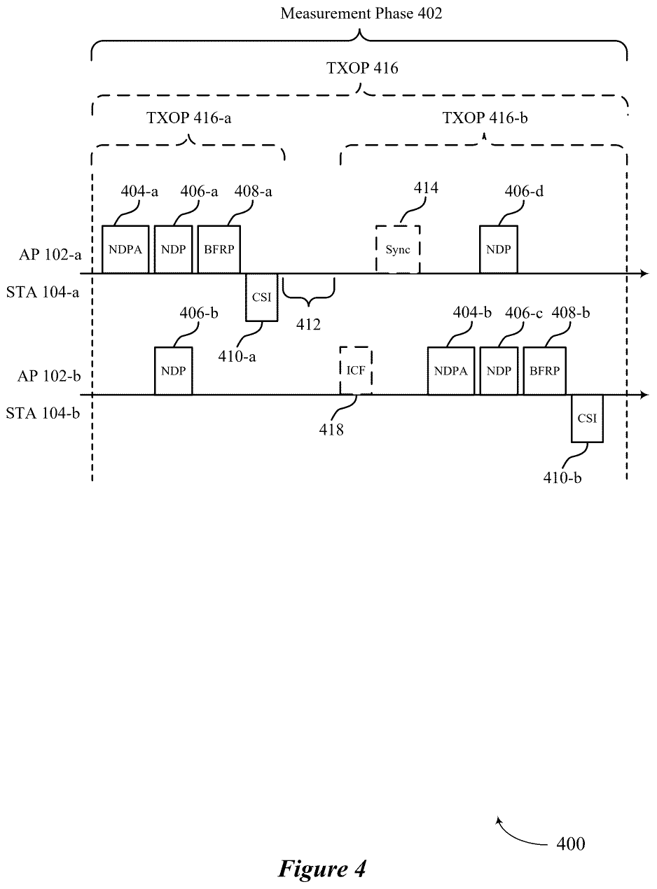

Joint channel sounding, in contrast, may aim to perform the sounding process in a more efficient way by performing CSI estimation to the associated AP 102-a as well as the OBSS AP 102-b simultaneously. A similar sounding sequence to that of sequential sounding may be used, but with the following differences. In joint channel sounding, one or more NDP frames may be sent jointly by both APs 102 at the same time. In such cases, CSI estimation to the two APs 102 can be done using a separate set of LTFs. Joint channel sounding may save up to three frame exchanges per AP 102 compared to sequential channel sounding, which may reduce the overhead of the sounding sequence. Additional details related to joint channel sounding are described in further detail herein with reference to FIG. 4.

During the transmission phase of the CBF operation, the two or more APs 102 may agree on which clients (e.g., STAs 104) will be served by each AP 102 during a shared TXOP and whether or not each AP 102 can null an associated transmission signal at the one or more clients of the other AP 102. Such an agreement may be achieved by means of the following three-way handshaking sequence. First, the first AP 102-a (e.g., a sharing AP) may share common preamble information in addition to which client (e.g., the first STA 104-a) or clients the first AP 102-a will serve via a CBF trigger frame (e.g., the CBF trigger frame may be associated with triggering one or more STAs 104 to transition from a first operating state to a second operating state).

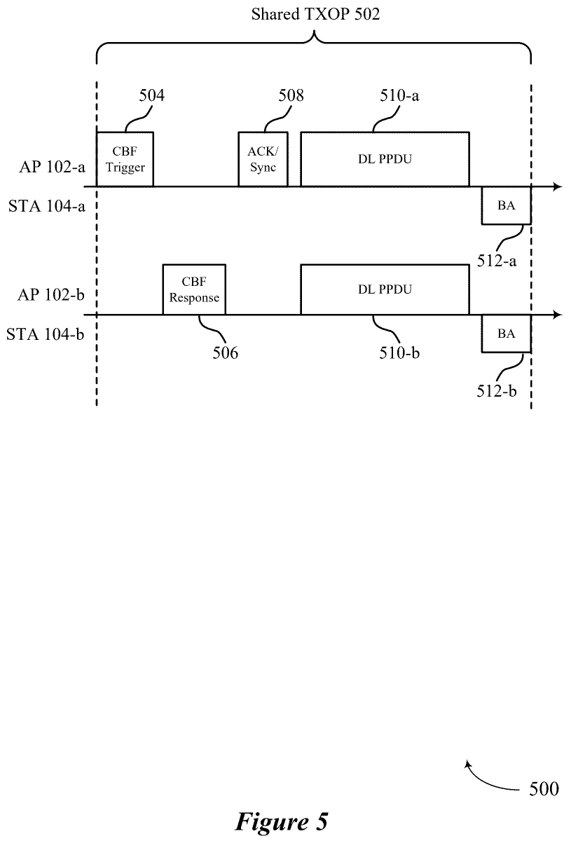

The sharing AP may own the shared TXOP. For example, in order to generate a common portion of later downlink PPDUs (e.g., CBF messaging) at the first AP 102-a and the second AP 102-b with at least a portion of the file headers in common, the APs 102 may agree on one or more parameters. Second, the second AP 102-b (e.g., a shared AP) may acknowledge that the second AP 102-b can null an associated signal at the first AP 102-a client (e.g., the first STA 104-a) and declares which client the second AP 102-b will serve (e.g., the second STA 104-b) via a CBF response frame (e.g., based on the CBF trigger frame). The shared AP may use the shared TXOP. Third, the first AP 102-a may acknowledge that the second AP 102-b can null an associated signal at the second AP 102-b client (e.g., the second STA 104-b) via an ACK/Sync frame. The ACK/Sync frame may be used for synchronizing data transmissions, sharing information for creating a common preamble for downlink PPDUs, or both. Additional details related to joint channel sounding are described in further detail herein with reference to FIG. 5-7.

In some cases, there may be an offset (e.g., difference) between carrier frequencies associated with the two or more APs 102 participating in a CBF process. If a CFO between the APs 102 participating in the CBF process is left uncorrected, the APs 102 may experience performance degradation. The CFO may apply to both the channel sounding phase and the transmission phase of the CBF process. Additionally, the CFO may apply to both sequential channel sounding and joint channel sounding.

For example, during the transmission phase, the two or more APs 102 are expected to transmit a common (e.g., shared) preamble at the beginning of a joint downlink PPDU (e.g., transmitted simultaneously), which may include frequency alignment (e.g., frequency synchronization) between the two or more APs 102. Additionally, because the two or more APs 102 perform CBF transmission using frequency synchronization, the CSI information used for beam nulling (e.g., nulling signals) may also include frequency synchronization. In this way, the frequency reference used during the transmission phase (e.g., to correct the CFO between the two or more APs 102) may be the same as the frequency reference used for the channel sounding phase.

In some examples, one of the two or more APs 102 (e.g., the first AP 102-a) may align a carrier frequency (e.g., a transmission frequency) of the first AP 102-a with a carrier frequency of the second AP 102-b. For example, the second AP 102-b may act as a frequency reference for the first AP 102-a. In such examples, the second AP 102-b may transmit signaling to the first AP 102-a, which the first AP 102-a may use to align a carrier frequency of the first AP 102-a. In some cases, the role of frequency reference (e.g., which AP 102 acts as the frequency reference) may be negotiated at an initial stage of establishing a CBF agreement between the two or more APs 102. Such a negotiation may occur on a longer-term basis (e.g. less frequently) than the channel sounding and transmission phases. In some other cases, the AP 102 that initiates the channel sounding phase may be (e.g., act as) the frequency reference.

In some cases where the first AP 102-a and the second AP 102-b perform channel sounding for each TXOP (e.g., each shared TXOP), the first AP 102-a and the second AP 102-b may also perform frequency synchronization for each shared TXOP. However, in some other cases where the first AP 102-a and the second AP 102-b perform channel sounding on a long-term basis (e.g., perform channel sounding for multiple shared TXOPs), frequency alignment between the first AP 102-a and the second AP 102-b may be more complicated. For example, because the frequency reference role is negotiated less frequently than channel sounding and transmission, there may be cases where the AP 102 acting as the frequency reference is a shared AP and not a sharing AP 102 for a given shared TXOP (e.g., does not own the shared TXOP). In such cases, the shared AP 102 may be unable to transmit signaling in the shared TXOP prior to receiving signaling from a sharing AP 102 indicating that the shared AP 102 can transmit in the shared TXOP. Consequently, the sharing AP 102 may not receive signaling to use as a frequency reference, and the shared AP 102 and the sharing AP 102 may be unable to correct CFO during the transmission phase. Accordingly, various aspects of the present disclosure relate to CFO compensation between APs 102 for CBF sounding and transmission.

FIG. 3 shows an example of a signaling diagram 300 that supports CFO compensation between access points for CBF sounding and transmission. In some examples, the signaling diagram 300 may implement aspects of the wireless communications network 100 and the signaling diagram 200. For example, the signaling diagram 300 may include a first AP 102-a, a second AP 102-b, a first STA 104-a, a second STA 104-b, which may be examples of the corresponding devices described herein, including with reference to FIG. 1. In some examples, the signaling diagram 300 may include additional features not mentioned below, or further operations may be added. Additionally, or alternatively, while two APs 102 and two STAs 104 are shown in the signaling diagram 300, more devices may be possible and the examples shown should not be construed as limiting. Each frame in the signaling diagram 300 and in other signaling diagrams described herein may be separated in time from neighboring frames by a short interframe space (SIFS) (e.g., a delay in microseconds).

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 300 may illustrate an example of a sequential CBF channel sounding procedure between the first AP 102-a, the second AP 102-b, the first STA 104-a, and the second STA 104-b, described herein with reference to FIG. 2. The sequential channel sounding procedure may occur within a measurement phase 302 of a CBF procedure. In some cases, the measurement phase 302 may represent (e.g., include) one TXOP 316. In such cases, the first AP 102-a and the second AP 12-b may perform channel sounding in both the first BSS and the second BSS during the TXOP 316. In some other cases, the measurement phase 302 may represent multiple TXOPs 316, including a first TXOP 316-a and a second TXOP 316-b. In such cases, the first AP 102-a and the second AP 12-b may perform channel sounding in the first BSS during the first TXOP 316-a and may perform channel sounding in the second BSS during the second TXOP 316-b.

During the sequential channel sounding procedure, the first AP 102-a and the second AP 102-b may collect CSI 310 from each BSS in the OBSS. For example, the first AP 102-a may collect first CSI 310-a associated with a wireless channel between the first STA 104-a and the first AP 102-a, and fourth CSI 310-d associated with a wireless channel between the second STA 104-b and the first AP 102-a. Similarly, the second AP 102-b may collect second CSI 310-b associated with a wireless channel between the first STA 104-a and the second AP 102-b, and third CSI 310-c associated with a wireless channel between the second STA 104-b and the second AP 102-b. In the example of FIG. 3, the first AP 102-a may act as a frequency reference for the second AP 102-b. That is, the second AP 102-b may adjust a carrier frequency of the second AP 102-b to align with a carrier frequency of the first AP 102-a.

In a first half of the sequential channel sounding procedure, the first AP 102-a may collect CSI 310 from the first BSS (e.g., the first STA 104-a). For example, the first AP 102-a may transmit a first NDPA frame 304-a to the first STA 104-a. In some examples, the first NDPA frame 304-a may indicate, to the first STA 104-a, that the first AP 102-a is to transmit a first NDP frame 306-a that the first STA 104-a is to use to estimate a wireless channel between the first STA 104-a and the first AP 102-a. After transmitting the first NDPA frame 304-a, the first AP 102-a may transmit a first NDP frame 306-a and a first BFRP frame 308-a to the first STA 104-a. The first STA 104-a may respond to the first AP 102-a with a first CSI 310-a, which may describe the channel between the first STA 104-a and the first AP 102-a.

After receiving the first CSI 310-a from the first STA 104-a, the first AP 102-a may transmit a second NDPA frame 304-b to the first STA 104-a on behalf of the second AP 102-b. In some examples, the second NDPA frame 304-b may indicate, to the second AP 102-b, that the second AP 102-b is to transmit a second NDP frame 306-b that the first STA 104-a is to use to estimate a wireless channel between the first STA 104-a and the second AP 102-b. To transmit the second NDP frame 306-b to the first STA 104-a during the measurement phase 302 (e.g., during the channel sounding phase), the second AP 102-b may perform CFO alignment and correct for a CFO between the first AP 102-a and the second AP 102-b. Such CFO alignment during the channel sounding phase may use the second NDPA frame 304-b transmitted by the first AP 102-a. Additionally, or alternatively, the second AP 102-b may use the first NDPA frame 304-a as a frequency reference frame for estimating the CFO. The second AP 102-b may monitor for the second NDPA frame 304-b and estimate the CFO between the first AP 102-a and the second AP 102-b using the second NDPA frame 304-b. After estimating the CFO, the second AP 102-b may pre-compensate for the CFO before transmitting the second NDP frame 306-b to the first STA 104-a. The first AP 102-a may transmit a second BFRP frame 308-b to the first STA 104-a. The first STA 104-a may transmit a second CSI 310-b, which may describe the channel between the first STA 104-a and the second AP 102-b. The second CSI 310-b may be received and decoded by the second AP 102-b. The CSI information included in the second CSI 310-b may be stored at the second AP 102-b to be used later during a transmission phase of the CBF operation for nulling the second AP's 102-b signal at the first STA 104-a to minimize interference.

The second half of the measurement phase 302 may mirror the first half of the measurement phase 302, but performed by the second AP 102-b and the first AP 102-a with the second STA 104-b associated with the second BSS. The second AP 102-b may collect CSI 310 from the second BSS (e.g., the second STA 104-b). For example, the second AP 102-b may transmit a third NDPA frame 304-c to the second STA 104-b. In some examples, the third NDPA frame 304-c may indicate, to the second STA 104-b, that the second AP 102-b is to transmit a third NDP frame 306-c that the second STA 104-b is to use to estimate a wireless channel between the second STA 104-b and the second AP 102-b. After transmitting the third NDPA frame 304-c, the second AP 102-b may transmit a third NDP frame 306-c and a third BFRP frame 308-c to the second STA 104-b. In some examples, the second AP 102-b may continue to pre-compensate for the CFO for all transmissions during the measurement phase 302 including the third NDPA frame 304-c, the third NDP frame 306-c, and the third BFRP frame 308-c. In some other examples, the second AP 102-b may only pre-compensate the CFO for the third NDP frame 306-c.

The second STA 104-b may respond to the second AP 102-b with a third CSI 310-c, which may describe the channel between the second STA 104-b and the second AP 102-b. After receiving the third CSI 310-c from the second STA 104-b, the second AP 102-b may transmit a fourth NDPA frame 304-d to the second STA 104-b on behalf of the first AP 102-a. In some examples, the fourth NDPA frame 304-d may indicate, to the first AP 102-a, that the first AP 102-a is to transmit a fourth NDP frame 306-d that the second STA 104-b is to use to estimate a wireless channel between the second STA 104-b and the first AP 102-a. The first AP 102-a may transmit the fourth NDP frame 306-d to the second STA 104-b. The second AP 102-b may transmit a second BFRP frame 308-b to the second STA 104-b. In some examples, the second AP 102-b may continue to pre-compensate for the CFO for all transmissions during the measurement phase 302 including the fourth NDPA frame 304-d and the fourth BFRP frame 308-d. The second STA 104-b may transmit a fourth CSI 310-d, which may describe the channel between the second STA 104-b and the first AP 102-a. The fourth CSI 310-d may be received and decoded by the first AP 102-a. The CSI information included in the fourth CSI 310-d may be stored at the first AP 102-a to be used later during a transmission phase of the CBF operation for nulling the first AP's 102-a signal at the second STA 104-b to minimize interference.

In the example of FIG. 3, channel sounding in the first BSS (e.g., the first half of the channel sounding procedure between the first AP 102-a and the second AP 102-b and the first STA 104-a) and channel sounding in the second BSS (e.g., the second half of the channel sounding procedure between the second AP 102-b and the first AP 102-a and the second STA 104-b) may occur consecutively. However, in some other examples, channel sounding in the first BSS and channel sounding in the second BSS may be performed non-consecutively. For example, when performing channel sounding within a single TXOP 316, there may be a delay 312 (e.g., a SIFS) between the first half of the channel sounding procedure and the second half of the channel sounding procedure. In such cases, the AP 102 acting as the frequency reference (e.g., the first AP 102-a) may transmit a synchronization frame 314 to the second AP 102-b. The synchronization frame 314 may act as a frequency reference frame for the second AP 102-b to estimate (e.g., re-estimate) the CFO between the first AP 102-a and the second AP 102-b for performing the second half of the channel sounding procedure.

In some other examples, the first AP 102-a and the second AP 102-b may perform non-consecutive channel sounding in two different TXOPs 316 (e.g., the first TXOP 316-a and the second TXOP 316-b). In some cases, the second AP 102-b may store the CFO estimated during the first half of the channel sounding procedure (e.g., the first TXOP 316-a) and may reuse the previously-estimated CFO during the second half of the channel sounding procedure (e.g., the second TXOP 316-b). In some other cases, the first AP 102-a and the second AP 102-b may communicate additional frames at the beginning of the second half of the channel sounding procedure (e.g., the beginning of the second TXOP 316-b) to act as a frequency reference. In some cases, the first AP 102-a may initiate channel sounding in the second BSS (e.g., the second half of the channel sounding procedure) by transmitting the synchronization frame 314 to the second AP 102-b (e.g., at the beginning of the second TXOP 316-b). The second AP 102-b may use the synchronization frame 314 as a frequency reference frame and may estimate the CFO between the first AP 102-a and the second AP 102-b for performing the second half of the channel sounding procedure.

In some other cases, the second AP may initiate channel sounding in the second BSS by transmitting an ICF 318 to the first AP 102-a. The first AP 102-a may respond to the ICF 318 with the synchronization frame 314. In such cases, the synchronization frame 314 may be a ICR frame responsive to the ICF 318. Because the ICR frame is acting as the synchronization frame 314 (e.g., the frequency reference frame) for the second AP 102-b, the first AP 102-a may refrain from synchronizing the ICR frame to the ICF 318. The second AP 102-b may use the synchronization frame 314 as a frequency reference frame and may estimate the CFO between the first AP 102-a and the second AP 102-b and pre-compensate it before transmission(s) for performing the second half of the channel sounding procedure.

Additionally, or alternatively, in some examples each half of the channel sounding procedure may occur over multiple TXOPs 316. For example, channel sounding between the first AP 102-a and the first STA 104-a may occur within a first TXOP 316-a, and channel sounding between the second AP 102-b and the first STA 104-a may occur within a second TXOP 316-b. Similarly, channel sounding between the second AP 102-b and the second STA 104-b may occur within a third TXOP 316 (not shown), and channel sounding between the first AP 102-a and the second STA 104-b may occur within a fourth TXOP 316 (not shown). In such examples, the first AP 102-a and the second AP 102-b may communicate additional signaling (e.g., frames) at the beginning of the second TXOP 316-b (e.g., and the fourth TXOP 316) to act as a new frequency reference frame. The second AP 102-b may estimate the CFO between the first AP 102-a and the second AP 102-b using the new frequency reference frame. In some cases, the new frequency reference frame may be a synchronization frame 314. In some other cases, the new frequency reference frame may be an ICR frame responsive to an ICF 318.

Implementation of the signaling diagram 300 for CFO compensation between access points for CBF sounding may be associated with various advantages. For example, implementation of the signaling diagram 300 by the first AP 102-a and the second AP 102-b may support CFO estimation and compensation in multiple BSSs for sequential channel sounding, including channel sounding performed consecutively or performed non-consecutively over a single TXOP 316 or over multiple TXOPs 316.

FIG. 4 shows an example of a signaling diagram 400 that supports CFO compensation between access points for CBF sounding. In some examples, the signaling diagram 400 may implement aspects of the wireless communications network 100 and the signaling diagram 200. For example, the signaling diagram 400 includes a first AP 102-a, a second AP 102-b, a first STA 104-a, a second STA 104-b, which may be examples of the corresponding devices described herein, including with reference to FIG. 1. In some examples, the signaling diagram 400 may include additional features not mentioned below, or further operations may be added. Additionally, or alternatively, while two APs 102 and two STAs 104 are shown in the signaling diagram 400, more devices may be possible and the examples shown should not be construed as limiting. Each frame in the signaling diagram 400 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 400 may illustrate an example of a joint CBF channel sounding procedure between the first AP 102-a, the second AP 102-b, the first STA 104-a, and the second STA 104-b, described herein with reference to FIG. 2. The joint CBF channel sounding procedure may occur within a measurement phase 402 of a CBF procedure. In some cases, the measurement phase 402 may represent (e.g., include) one TXOP 416. In such cases, the first AP 102-a and the second AP 12-b may perform channel sounding in both the first BSS and the second BSS during the TXOP 416. In some other cases, the measurement phase 402 may represent multiple TXOPs 416, including a first TXOP 416-a and a second TXOP 416-b. In such cases, the first AP 102-a and the second AP 12-b may perform channel sounding in the first BSS during the first TXOP 416-a and may perform channel sounding in the second BSS during the second TXOP 416-b.

The joint CBF channel sounding sequence of the signaling diagram 400 may be similar to the sequential CBF channel sounding sequence of the signaling diagram 300, except that one or more frames may be sent jointly (e.g., in parallel, simultaneously) by both the first AP 102-a and the second AP 102-b at the same time. Devices in the signaling diagram 400 may perform the CBF sounding process in a more efficient way than illustrated in the signaling diagram 300 by performing the CSI estimation to an associated AP 102 as well as the OBSS AP 102 simultaneously. For example, the joint channel sounding sequence of the signaling diagram 400 may save up to three frame exchanges per BSS compared to the sequential channel sounding sequence of the signaling diagram 300, which may reduce the overhead of the sounding sequence. In the example of FIG. 4, the first AP 102-a may act as a frequency reference for the second AP 102-b. That is, the second AP 102-b may adjust a carrier frequency of the second AP 102-b to align with a carrier frequency of the first AP 102-a.

In a first half of the joint channel sounding procedure, the first AP 102-a may collect CSI 410 from the first BSS (e.g., the first STA 104-a). For example, the first AP 102-a may transmit a first NDPA frame 404-a to the first STA 104-a. In some examples, the first NDPA frame 404-a may prepare the first STA 104-a to receive both a first NDP frame 406-a from the first AP 102-a and a second NDP frame 406-b from the second AP 102-b simultaneously (such as in parallel, concurrently, in separate sets of LTFs). The first STA 104-a may receive the first NDP frame 406-a and the second NDP frame 406-b. Additionally, the first STA 104-a may receive a first BFRP frame 408-a from the first AP 102-a. The first STA 104-a may use the NDP frames 406 to collect and transmit, to the first AP 102-a, first CSI 410-a including CSI associated with a wireless channel between the first STA 104-a and the first AP 102-a and a wireless channel between the first STA 104-a and the second AP 102-b.

To transmit the second NDP frame 406-b to the first STA 104-a during the measurement phase 402 (e.g., during the channel sounding phase), the second AP 102-b may perform CFO alignment and correct for a CFO between the first AP 102-a and the second AP 102-b. Such CFO alignment during the channel sounding phase may use the first NDPA frame 404-a transmitted by the first AP 102-a. For example, the second AP 102-b may use the first NDPA frame 404-a as a frequency reference frame for estimating the CFO. The second AP 102-b may monitor for the first NDPA frame 404-a and estimate the CFO between the first AP 102-a and the second AP 102-b using the first NDPA frame 404-a. After estimating the CFO, the second AP 102-b may pre-compensate for the CFO before transmitting the second NDP frame 406-b to the first STA 104-a.

The second half of the measurement phase 402 may mirror the first half of the measurement phase 402, but performed by the second AP 102-b and the first AP 102-a with the second STA 104-b associated with the second BSS. The second AP 102-b may collect CSI 410 from the second BSS (e.g., the second STA 104-b). For example, the second AP 102-b may transmit a second NDPA frame 404-b to the second STA 104-b. In some examples, the second NDPA frame 404-b may prepare the second STA 104-b to receive both a third NDP frame 406-c from the first AP 102-a and a fourth NDP frame 406-d from the second AP 102-b simultaneously. The second STA 104-b may receive the third NDP frame 406-c and the fourth NDP frame 406-d. Additionally, the second STA 104-b may receive a second BFRP frame 408-b from the second AP 102-b. In some examples, the second AP 102-b may continue to pre-compensate for the CFO for all transmissions during the measurement phase 402 including the second NDPA frame 404-b, the third NDP frame 406-c, and the second BFRP frame 408-b. In some other examples, the second AP 102-b may only pre-compensate for the CFO for the third NDP frame 406-c. The second STA 104-b may use the NDP frames 406 to collect and transmit, to the second AP 102-b, second CSI 410-b including CSI associated with a wireless channel between the second STA 104-b and the second AP 102-b and a wireless channel between the second STA 104-b and the first AP 102-a. The second CSI 310-b may be received and decoded by the second AP 102-b. The CSI information included in the second CSI 310-b may be stored at the second AP 102-b to be used later during the transmission phase for nulling the second AP's 102-b signal at the first STA 104-a to minimize interference.

In the example of FIG. 4, channel sounding in the first BSS (e.g., the first half of the channel sounding procedure between the first AP 102-a, the second AP 102-b, and the first STA 104-a) and channel sounding in the second BSS (e.g., the second half of the channel sounding procedure between the second AP 102-b, the first AP 102-a, and the second STA 104-b) may occur consecutively. However, in some other examples, channel sounding in the first BSS and channel sounding in the second BSS may be performed non-consecutively. For example, there may be a delay 412 (e.g., a SIFS) between the first half of the channel sounding procedure and the second half of the channel sounding procedure. In such cases, the AP 102 acting as the frequency reference (e.g., the first AP 102-a) may transmit a synchronization frame 414 to the second AP 102-b. The second AP 102-b may estimate (e.g., re-estimate) the CFO between the first AP 102-a and the second AP 102-b using the synchronization frame 414.

In some other examples, the first AP 102-a and the second AP 102-b may perform non-consecutive channel sounding in two different TXOPs 416 (e.g., the first TXOP 416-a and the second TXOP 416-b). In some cases, the second AP 102-b may store the CFO estimated during the first half of the channel sounding procedure (e.g., the first TXOP 416-a) and may reuse the previously-estimated CFO during the second half of the channel sounding procedure (e.g., the second TXOP 416-b). In some other cases, the first AP 102-a and the second AP 102-b may communicate additional frames at the beginning of the second half of the channel sounding procedure (e.g., the beginning of the second TXOP 416-b) to act as a frequency reference. In some cases, the first AP 102-a may initiate channel sounding in the second BSS (e.g., the second half of the channel sounding procedure) by transmitting the synchronization frame 414 to the second AP 102-b (e.g., at the beginning of the second TXOP 416-b). The second AP 102-b may use the synchronization frame 414 as a frequency reference frame and may estimate the CFO between the first AP 102-a and the second AP 102-b for performing the second half of the channel sounding procedure.

In some other cases, the second AP may initiate channel sounding in the second BSS by transmitting an ICF 418 to the first AP 102-a. The first AP 102-a may respond to the ICF 418 with the synchronization frame 414. In such cases, the synchronization frame 414 may be a ICR frame responsive to the ICF 418. Because the ICR frame is acting as the synchronization frame 414 (e.g., the frequency reference frame) for the second AP 102-b, the first AP 102-a may refrain from synchronizing the ICR frame to the ICF 418. The second AP 102-b may use the synchronization frame 414 as a frequency reference frame and may estimate the CFO between the first AP 102-a and the second AP 102-b and pre-compensate it before transmission(s) for performing the second half of the channel sounding procedure.

Additionally, or alternatively, in some examples each half of the channel sounding procedure may occur over multiple TXOPs 416. For example, channel sounding between the first AP 102-a and the first STA 104-a may occur within a first TXOP 416-a, and channel sounding between the second AP 102-b and the first STA 104-a may occur within a second TXOP 416-b. Similarly, channel sounding between the second AP 102-b and the second STA 104-b may occur within a third TXOP 416 (not shown), and channel sounding between the first AP 102-a and the second STA 104-b may occur within a fourth TXOP 416 (not shown). In such examples, the first AP 102-a and the second AP 102-b may communicate additional signaling (e.g., frames) at the beginning of the second TXOP 416-b (e.g., and the fourth TXOP 416) to act as a new frequency reference frame. The second AP 102-b may estimate the CFO between the first AP 102-a and the second AP 102-b using the new frequency reference frame. In some cases, the new frequency reference frame may be a synchronization frame 414. In some other cases, the new frequency reference frame may be an ICR frame responsive to an ICF 418.

Implementation of the signaling diagram 400 for CFO compensation between access points for CBF sounding and transmission may be associated with various advantages. For example, implementation of the signaling diagram 400 by the first AP 102-a and the second AP 102-b may support CFO estimation and compensation in multiple BSSs for joint channel sounding, including channel sounding performed consecutively or performed non-consecutively over a single TXOP 416 or over multiple TXOPs 416.

FIG. 5 shows an example of a signaling diagram 500 that supports CFO compensation between access points for CBF transmission. In some examples, the signaling diagram 500 may implement aspects of the wireless communications network 100 and the signaling diagram 200. For example, the signaling diagram 500 includes a first AP 102-a, a second AP 102-b, a first STA 104-a, a second STA 104-b, which may be examples of the corresponding devices described herein, including with reference to FIG. 1. In some examples, the signaling diagram 500 may include additional features not mentioned below, or further operations may be added. Additionally, or alternatively, while two APs 102 and two STAs 104 are shown in the signaling diagram 500, more devices may be possible and the examples shown should not be construed as limiting. Each frame in the signaling diagram 500 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 500 may illustrate an example of a CBF transmission procedure (e.g., a CBF transmission phase) between the first AP 102-a, the second AP 102-b, the first STA 104-a, and the second STA 104-b, described herein with reference to FIG. 2. The CBF transmission phase may occur within a shared TXOP 502. The shared TXOP 502 may be available for transmissions from both the first AP 102-a and the second AP 102-b. In the example of FIG. 5, the first AP 102-a may be a sharing AP 102, and the second AP 102-b may be a shared AP 102. That is, the first AP 102-a may be an owner of the shared TXOP 502, and the first AP 102-a may share the shared TXOP 502 with the second AP 102-b. Additionally, in the example of FIG. 5, the first AP 102-a may act as a frequency reference for the second AP 102-b. That is, the second AP 102-b may adjust a carrier frequency of the second AP 102-b to align with a carrier frequency of the first AP 102-a.

The sharing AP 102 (e.g., the first AP 102-a) may initiate the CBF transmission procedure by transmitting a CBF trigger frame 504 to the shared AP 102 (e.g., the second AP 102-b). The second AP 102-b may respond to the CBF trigger frame 504 by transmitting a CBF response frame 506 to the first AP 102-a. After receiving the CBF response frame 506 from the second AP 102-b, the first AP 102-a may transmit an ACK/Synch frame 508 to the second AP 102-b. After communication of the ACK/Synch frame 508, both the first AP 102-a and the second AP 102-b may transmit a downlink PPDU 510 to a respective STA 104. For example, the first AP 102-a may transmit a first downlink PPDU 510-a to the first STA 104-a, and the second AP 102-b may transmit a second downlink PPDU 510-b to the second STA 104-b. Responsive to receiving the downlink PPDUs 510, each STA 104 may transmit a block acknowledgement (BA) frame 512 to a respective AP 102. For example, the first STA 104-a may transmit a first BA frame 512-a to the first AP 102-a, and the second STA 104-b may transmit a second BA frame 512-b to the second AP 102-b.

To transmit the second downlink PPDU 510-b to the second STA 104-b during the shared TXOP 502 (e.g., during the transmission phase), the second AP 102-b may perform CFO alignment and correct for a CFO between the first AP 102-a and the second AP 102-b. By doing this, the first downlink PPDU 510-a and the second downlink PPDU 510-b may be aligned in frequency with respect to the first AP 102-a (e.g., the frequency reference). In some examples, the second AP 102-b may perform CFO alignment during the transmission phase using the ACK/Synch frame 508 transmitted by the first AP 102-a. The second AP 102-b may receive the ACK/Synch frame 508 and estimate the CFO between the first AP 102-a and the second AP 102-b using the ACK/Synch frame 508. After estimating the CFO, the second AP 102-b may pre-compensate for the CFO before transmitting the second downlink PPDU 510-b to the second STA 104-b.

In some other examples, the second AP 102-b may perform CFO alignment during the transmission phase using the CBF trigger frame 504 transmitted by the first AP 102-a. For example, the second AP 102-b may use the CBF trigger frame 504 as a frequency reference frame for estimating the CFO. The second AP 102-b may receive the CBF trigger frame 504 and estimate the CFO between the first AP 102-a and the second AP 102-b using the CBF trigger frame 504. After estimating the CFO, the second AP 102-b may pre-compensate for the CFO before transmitting the CBF response frame 506 to the first AP 102-a. The ACK/Synch frame 508 may be used by the second AP 102-b for additional synchronization with the first AP 102-a. For example, the second AP 102-b may use the ACK/Synch frame 508 to align transmission of the second downlink PPDU 510-b by the second AP 102-b with the first downlink PPDU 510-a by the first AP 102-a in time. Additionally, the ACK/Synch frame 508 may indicate successful receipt of the CBF response frame 506.

Implementation of the signaling diagram 500 for CFO compensation between access points for CBF transmission may be associated with various advantages. For example, implementation of the signaling diagram 500 by the first AP 102-a and the second AP 102-b may support CFO estimation and compensation in multiple BSSs for transmissions over a shared TXOP 502 in cases where the AP 102 acting as a frequency reference also owns the shared TXOP 502 and initiates a CBF procedure.

FIG. 6 shows an example of a signaling diagram 600 that supports CFO compensation between access points for CBF transmission. In some examples, the signaling diagram 600 may implement aspects of the wireless communications network 100 and the signaling diagram 200. For example, the signaling diagram 600 includes a first AP 102-a, a second AP 102-b, a first STA 104-a, a second STA 104-b, which may be examples of the corresponding devices described herein, including with reference to FIG. 1. In some examples, the signaling diagram 600 may include additional features not mentioned below, or further operations may be added. Additionally, or alternatively, while two APs 102 and two STAs 104 are shown in the signaling diagram 600, more devices may be possible and the examples shown should not be construed as limiting. Each frame in the signaling diagram 600 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 600 may illustrate an example of a CBF transmission procedure (e.g., a CBF transmission phase) between the first AP 102-a, the second AP 102-b, the first STA 104-a, and the second STA 104-b, described herein with reference to FIG. 2. The CBF transmission phase may occur within a shared TXOP 602. The shared TXOP 602 may be available for transmissions from both the first AP 102-a and the second AP 102-b. In the example of FIG. 6, the first AP 102-a may be a sharing AP 102, and the second AP 102-b may be a shared AP 102. That is, the first AP 102-a may be an owner of the shared TXOP 502, and the first AP 102-a may share the shared TXOP 502 with the second AP 102-b. Additionally, in the example of FIG. 6, the second AP 102-b may act as a frequency reference for the first AP 102-a. That is, the first AP 102-a may adjust a carrier frequency (e.g., perform frequency compensation) of the first AP 102-a to align with a carrier frequency of the second AP 102-b.

However, in some cases where the first AP 102-a is both the owner of the shared TXOP 602 and is to perform frequency compensation based on the second AP 102-b, the first AP 102-a may initiate the CBF transmission procedure. In such cases, the first AP 102-a may not receive signaling from the second AP 102-b during the shared TXOP 602 to use as a frequency reference (e.g., for frequency alignment) prior to transmitting a first message initiating the CBF transmission procedure.

In some examples, the sharing AP 102 (e.g., the first AP 102-a) may initiate the CBF transmission procedure by transmitting a CBF trigger frame 604 to the shared AP 102 (e.g., the second AP 102-b). In such examples, the first AP 102-a may transmit the CBF trigger frame 604 without frequency pre-compensation. The first AP 102-a may wait for a CBF response frame 606 from the second AP 102-b to use for CFO estimation. For example, the first AP 102-a may use the CBF response frame 606 as a frequency reference frame for estimating the CFO. After receiving the CBF response frame 606 and estimating the CFO between the first AP 102-a and the second AP 102-b, the first AP 102-a may pre-compensate for the CFO when transmitting subsequent signaling during the shared TXOP 602. For example, the first AP 102-a may transmit an ACK/Synch frame 608 to the second AP 102-b with frequency pre-compensation.

Additionally, or alternatively, both the first AP 102-a and the second AP 102-b may transmit a downlink PPDU 610 to a respective STA 104. The first AP 102-a may transmit a first downlink PPDU 610-a to the first STA 104-a, and the second AP 102-b may transmit a second downlink PPDU 610-b to the second STA 104-b. The first AP 102-a may pre-compensate for the CFO before transmitting the first downlink PPDU 610-a.

Alternatively, in some cases, the first AP 102-a and the second AP 102-b may transmit the downlink PPDUs 610 (e.g., the first downlink PPDU 610-a and the second downlink PPDU 610-b, respectively) directly after (e.g., a SIFS after) communication of the CBF response frame 606. For example, the first AP 102-a may refrain from transmitting an acknowledgement of the CBF response frame 606 (e.g., refrain from transmitting the ACK/Synch frame 608). In such cases, the first AP 102-a may pre-compensate for the CFO for transmitting the first downlink PPDU 610-a using the CBF response frame 606. The first AP 102-a may also synchronize transmission of the first downlink PPDU 610-a with transmission of the second downlink PPDU 610-b in time using the CBF response frame 606.

In some other examples, the sharing AP 102 (e.g., the first AP 102-a) may communicate additional messages with the shared AP 102 (e.g., the second AP 102-b) to estimate the CFO prior to initiating the CBF transmission procedure. For example, the first AP 102-a may transmit an initial control frame (ICF) 612 to the second AP 102-b prior to transmitting the CBF trigger frame 604. The ICF 612 may solicit a reference frame (e.g., a frequency reference frame) from the second AP 102-b. Responsive to receiving the ICF 612, the second AP 102-b may transmit an initial control response (ICR) frame 614 to the first AP 102-a. The first AP 102-a may use the ICR frame 614 as a frequency reference frame for estimating the CFO. After receiving the ICR frame 614 and estimating the CFO between the first AP 102-a and the second AP 102-b, the first AP 102-a may pre-compensate for the CFO when transmitting subsequent signaling during the shared TXOP 602, including the CBF trigger frame 604, the ACK/Synch frame 608, and the first downlink PPDU 610-a.

Alternatively, in some cases, the sharing AP 102 (e.g., the first AP 102-a) may not estimate the CFO during the transmission phase of a CBF procedure. Instead, the first AP 102-a may store a CFO value estimated during the channel sounding phase of the CBF procedure. CFO estimation during the channel sounding phase is described in further detail herein with respect to FIGS. 3 and 4. The first AP 102-a may use the stored CFO value for frequency pre-compensation for all frames transmitted by the first AP 102-a during the transmission phase, including the CBF trigger frame 604, the ACK/Synch frame 608, and the first downlink PPDU 610-a.

In some examples, the ACK/Synch frame 608 may be used by the second AP 102-b for additional synchronization with the first AP 102-a. For example, the second AP 102-b may use the ACK/Synch frame 608 to align transmission of the second downlink PPDU 610-b by the second AP 102-b with the first downlink PPDU 610-a by the first AP 102-a in time. Additionally, the ACK/Synch frame 608 may indicate successful receipt of the CBF response frame 606. Responsive to receiving the downlink PPDUs 610, each STA 104 may transmit a BA frame 616 to a respective AP 102. For example, the first STA 104-a may transmit a first BA frame 616-a to the first AP 102-a, and the second STA 104-b may transmit a second BA frame 616-b to the second AP 102-b.

Implementation of the signaling diagram 600 for CFO compensation between access points for CBF transmission may be associated with various advantages. For example, implementation of the signaling diagram 600 by the first AP 102-a and the second AP 102-b may support CFO estimation and compensation in multiple BSSs for transmissions over a shared TXOP 602 in cases where the AP 102 acting as a frequency reference does not own the shared TXOP 602 and initiates a CBF procedure.

FIG. 7 shows an example of a signaling diagram 700 that supports CFO compensation between access points for CBF transmission. In some examples, the signaling diagram 700 may implement aspects of the wireless communications network 100 and the signaling diagram 200. For example, the signaling diagram 700 includes a first AP 102-a, a second AP 102-b, a first STA 104-a, a second STA 104-b, which may be examples of the corresponding devices described herein, including with reference to FIG. 1. In some examples, the signaling diagram 700 may include additional features not mentioned below, or further operations may be added. Additionally, or alternatively, while two APs 102 and two STAs 104 are shown in the signaling diagram 700, more devices may be possible and the examples shown should not be construed as limiting. Each frame in the signaling diagram 700 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 700 may illustrate an example of a CBF transmission procedure (e.g., a CBF transmission phase) between the first AP 102-a, the second AP 102-b, the first STA 104-a, and the second STA 104-b, described herein with reference to FIG. 2. The CBF transmission phase may occur within a shared TXOP 702. The shared TXOP 702 may be available for transmissions from both the first AP 102-a and the second AP 102-b. In the example of FIG. 7, the first AP 102-a may be a sharing AP 102, and the second AP 102-b may be a shared AP 102. That is, the first AP 102-a may be an owner of the shared TXOP 702, and the first AP 102-a may share the shared TXOP 702 with the second AP 102-b. Additionally, in the example of FIG. 7, the second AP 102-b may act as a frequency reference for the first AP 102-a. That is, the first AP 102-a may adjust a carrier frequency (e.g., perform frequency compensation) of the first AP 102-a to align with a carrier frequency of the second AP 102-b.

As described herein with reference to FIGS. 5 and 6, there may be some examples where the first AP 102-a initiates the CBF transmission procedure. However, there may be some other examples where the second AP 102-b initiates the CBF transmission procedure. For example, the AP 102 that acts as the frequency reference (e.g., the second AP 102-b) may be configured (e.g., preconfigured) to initiate the CBF transmission procedure. In some cases where the first AP 102-a is the owner of the shared TXOP 702 (e.g., is the sharing AP 102), the first AP 102-a may request the second AP 102-b to initiate the CBF transmission sequence. For example, the first AP 102-a may transmit an ICF 704 to the second AP 102-b. The ICF 704 may request the second AP 102-b (e.g., the shared AP 102) to initiate the CBF transmission sequence. After receiving the ICF 704, the second AP 102-b may transmit a CBF trigger frame 706 to the first AP 102-a.

The first AP 102-a may respond to the CBF trigger frame 706 by transmitting a CBF response frame 708 to the second AP 102-b. After receiving the CBF response frame 708 from the first AP 102-a, the second AP 102-b may transmit an ACK/Synch frame 710 to the first AP 102-a. After communication of the ACK/Synch frame 710, both the first AP 102-a and the second AP 102-b may transmit a downlink PPDU 712 to a respective STA 104. For example, the first AP 102-a may transmit a first downlink PPDU 712-a to the first STA 104-a, and the second AP 102-b may transmit a second downlink PPDU 712-b to the second STA 104-b. Responsive to receiving the downlink PPDUs 712, each STA 104 may transmit a BA frame 714 to a respective AP 102. For example, the first STA 104-a may transmit a first BA frame 714-a to the first AP 102-a, and the second STA 104-b may transmit a second BA frame 714-b to the second AP 102-b.

To transmit the first downlink PPDU 712-a to the first STA 104-a during the shared TXOP 702 (e.g., during the transmission phase), the first AP 102-a may perform CFO alignment and correct for a CFO between the first AP 102-a and the second AP 102-b. By doing this, the first downlink PPDU 712-a and the second downlink PPDU 712-b may be aligned in frequency with respect to the second AP 102-b (e.g., the frequency reference). In some examples, the first AP 102-a may perform CFO alignment during the transmission phase using the ACK/Synch frame 710 transmitted by the second AP 102-b. For example, the first AP 102-a may use the ACK/Synch frame 710 as a frequency reference frame for estimating the CFO. The first AP 102-a may receive the ACK/Synch frame 710 and estimate the CFO between the first AP 102-a and the second AP 102-b using the ACK/Synch frame 710. After estimating the CFO, the first AP 102-a may pre-compensate for the CFO before transmitting the first downlink PPDU 712-a to the first STA 104-a.

In some other examples, the first AP 102-a may perform CFO alignment during the channel sounding phase using the CBF trigger frame 706 transmitted by the second AP 102-b. For example, the first AP 102-a may use the CBF trigger frame 706 as a frequency reference frame for estimating the CFO. The first AP 102-a may receive the CBF trigger frame 706 and estimate the CFO between the first AP 102-a and the second AP 102-b using the CBF trigger frame 706. After estimating the CFO, the first AP 102-a may pre-compensate for the CFO before transmitting the CBF response frame 708 to the first AP 102-a. The ACK/Synch frame 710 may be used by the first AP 102-a for additional synchronization with the second AP 102-b. For example, the first AP 102-a may use the ACK/Synch frame 710 to align transmission of the first downlink PPDU 712-a by the first AP 102-a with the second downlink PPDU 712-b by the second AP 102-b in time. Additionally, the ACK/Synch frame 710 may indicate successful receipt of the CBF response frame 708.

Implementation of the signaling diagram 700 for CFO compensation between access points for CBF transmission may be associated with various advantages. For example, implementation of the signaling diagram 700 by the first AP 102-a and the second AP 102-b may support CFO estimation and compensation in multiple BSSs for transmissions over a shared TXOP 702 in cases where the AP 102 acting as a frequency reference does not own the shared TXOP 702 and does not initiate a CBF procedure.

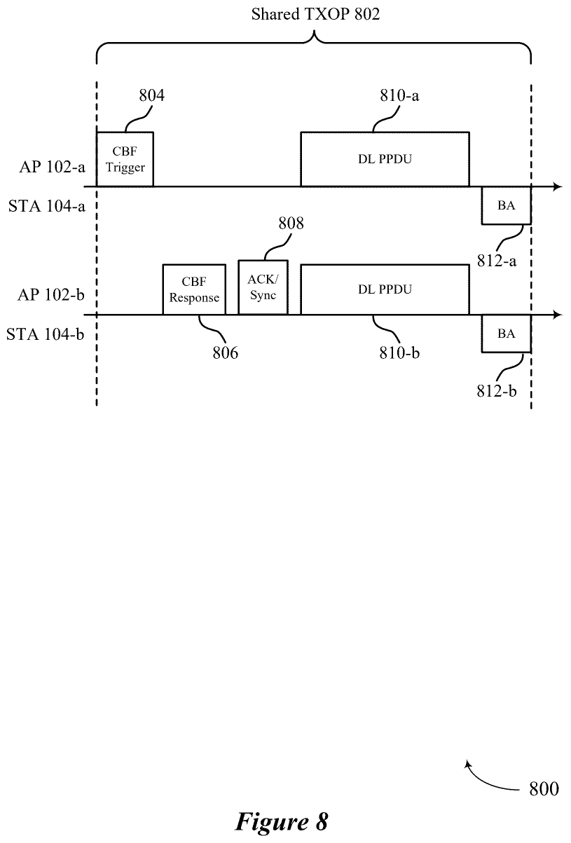

FIG. 8 shows an example of a signaling diagram 800 that supports CFO compensation between access points for CBF transmission. In some examples, the signaling diagram 800 may implement aspects of the wireless communications network 100 and the signaling diagram 200. For example, the signaling diagram 800 includes a first AP 102-a, a second AP 102-b, a first STA 104-a, a second STA 104-b, which may be examples of the corresponding devices described herein, including with reference to FIG. 1. In some examples, the signaling diagram 800 may include additional features not mentioned below, or further operations may be added. Additionally, or alternatively, while two APs 102 and two STAs 104 are shown in the signaling diagram 800, more devices may be possible and the examples shown should not be construed as limiting. Each frame in the signaling diagram 800 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The signaling diagram 800 may illustrate an example of a CBF transmission procedure (e.g., a CBF transmission phase) between the first AP 102-a, the second AP 102-b, the first STA 104-a, and the second STA 104-b, described herein with reference to FIG. 2. The CBF transmission phase may occur within a shared TXOP 802. The shared TXOP 802 may be available for transmissions from both the first AP 102-a and the second AP 102-b. In the example of FIG. 8, the first AP 102-a may be a sharing AP 102, and the second AP 102-b may be a shared AP 102. That is, the first AP 102-a may be an owner of the shared TXOP 802, and the first AP 102-a may share the shared TXOP 502 with the second AP 102-b. Additionally, in the example of FIG. 8, the second AP 102-b may act as a frequency reference for the first AP 102-a. That is, the first AP 102-a may adjust a carrier frequency (e.g., perform frequency compensation) of the first AP 102-a to align with a carrier frequency of the second AP 102-b.

For example, both the first AP 102-a and the second AP 102-b may transmit a downlink PPDU 810 to a respective STA 104. The first AP 102-a may transmit a first downlink PPDU 810-a to the first STA 104-a, and the second AP 102-b may transmit a second downlink PPDU 810-b to the second STA 104-b. The first AP 102-a may pre-compensate for a CFO between the first AP 102-a and the second AP 102-b before transmitting the first downlink PPDU 810-a. However, in some cases where the first AP 102-a is both the owner of the shared TXOP 802 and is to perform frequency compensation based on the second AP 102-b, the first AP 102-a may initiate the CBF transmission procedure. In such cases, the first AP 102-a may not receive signaling from the second AP 102-b during the shared TXOP 802 to use as a frequency reference (e.g., for frequency alignment) prior to transmitting a first message initiating the CBF transmission procedure.

In some examples, the sharing AP 102 (e.g., the first AP 102-a) may initiate the CBF transmission procedure by transmitting a CBF trigger frame 804 to the shared AP 102 (e.g., the second AP 102-b). In such examples, the first AP 102-a may transmit the CBF trigger frame 804 without frequency pre-compensation. The first AP 102-a may receive a CBF response frame 806 from the second AP 102-b. In some examples described herein with reference to FIG. 6, the first AP 102-a may estimate a CFO between the first AP 102-a and the second AP 102-b using the CBF response frame 806 and may transmit an ACK/Synch frame 808 to the second AP 102-b. However, in the example of FIG. 8, the first AP 102-a may refrain from transmitting the ACK/Synch frame 808 to the second AP 102-b.

Instead, in the example of FIG. 8, the second AP 102-b (e.g., the frequency reference) may transmit the ACK/Synch frame 808 (e.g., to the first AP 102-a). The second AP 102-b (e.g., the frequency reference) may be configured to always transmit the ACK/Synch frame 808 to the first AP 102-a. In such examples where the second AP 102-b (e.g., the frequency reference) is also the shared AP 102 (e.g., does not own the shared TXOP 802), the second AP 102-b may transmit the ACK/Synch frame 808 immediately after (e.g., a SIFS after) transmitting the CBF response frame 806.

Additionally, such examples where the second AP 102-b (e.g., the frequency reference) is also the shared AP 102 may introduce additional complexity (e.g., signaling complexity) at the MAC level, but configuring the second AP 102-b to transmit the ACK/Synch frame 808 may simplify PHY-level operations, including CFO estimation and frequency pre-compensation in subsequent frames.

The first AP 102-a may use the ACK/Synch frame 808 as a frequency reference frame for estimating the CFO. For example, the first AP 102-a may receive the ACK/Synch frame 808 and estimate the CFO between the first AP 102-a and the second AP 102-b using the ACK/Synch frame 808. After estimating the CFO, the first AP 102-a may pre-compensate for the CFO before transmitting the first downlink PPDU 712-a to the first STA 104-a. In some cases, the ACK/Synch frame 808 may be used by the first AP 102-a for additional synchronization with the second AP 102-b. For example, the first AP 102-a may use the ACK/Synch frame 808 to align transmission of the first downlink PPDU 810-a by the first AP 102-a with the second downlink PPDU 810-b by the second AP 102-b in time. Responsive to receiving the downlink PPDUs 810, each STA 104 may transmit a BA frame 812 to a respective AP 102. For example, the first STA 104-a may transmit a first BA frame 812-a to the first AP 102-a, and the second STA 104-b may transmit a second BA frame 812-b to the second AP 102-b.

Implementation of the signaling diagram 800 for CFO compensation between access points for CBF transmission may be associated with various advantages. For example, implementation of the signaling diagram 800 by the first AP 102-a and the second AP 102-b may support CFO estimation and compensation in multiple BSSs for transmissions over a shared TXOP 802 in cases where the AP 102 acting as a frequency reference does not own the shared TXOP 802 and where the AP 102 acting as a frequency reference is configured to always transmit a frequency reference frame.

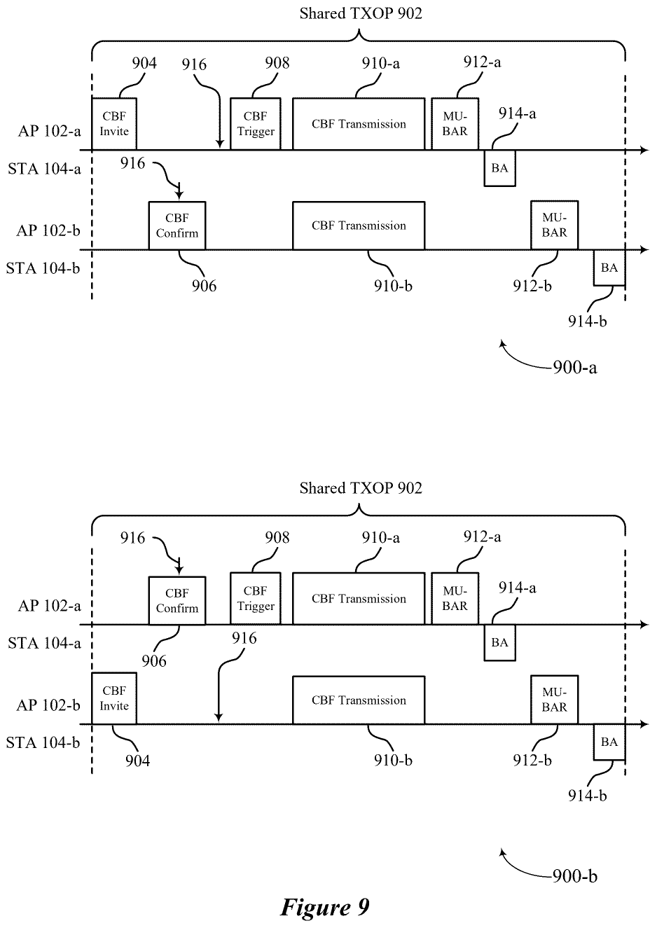

FIG. 9 shows an example of a signaling diagram 900 that supports CFO compensation between access points for CBF transmission. In some examples, the signaling diagrams 900 may implement aspects of the wireless communications network 100 and the signaling diagram 200. For example, the signaling diagrams 900 include a first AP 102-a, a second AP 102-b, a first STA 104-a, a second STA 104-b, which may be examples of the corresponding devices described herein, including with reference to FIG. 1. In some examples, the signaling diagrams 900 may include additional features not mentioned below, or further operations may be added. Additionally, or alternatively, while two APs 102 and two STAs 104 are shown in the signaling diagrams 900, more devices may be possible and the examples shown should not be construed as limiting. Each frame in the signaling diagrams 900 and in other signaling diagrams described herein may be separated in time from neighboring frames by a SIFS.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b.

The techniques described herein for CFO estimation and frequency pre-compensation for CBF sounding and CBF transmission may be extended to other CBF processes. For example, the signaling diagram 900 may illustrate a general example of a CBF procedure using medium contention (e.g., including a random backoff (RBO) element) between the first AP 102-a and the second AP 102-b, described herein with reference to FIG. 2. The CBF procedure may occur within a shared TXOP 902. The shared TXOP 902 may be available for transmissions from both the first AP 102-a and the second AP 102-b. In the example of FIG. 9, the first AP 102-a may act as a frequency reference for the second AP 102-b. That is, the second AP 102-b may adjust a carrier frequency of the second AP 102-b to align with a carrier frequency of the first AP 102-a.

In the signaling diagram 900-a, the first AP 102-a may be a sharing AP 102, and the second AP 102-b may be a shared AP 102. That is, in the signaling diagram 900-a, the first AP 102-a may be an owner of the shared TXOP 902, and the second AP 102-b may share the shared TXOP 902 with the first AP 102-a. The owner of the shared TXOP 902 (e.g., the first AP 102-a) may initiate a CBF procedure by transmitting a CBF Invite frame 904 (e.g., to the second AP 102-b). The second AP 102-b may receive the CBF Invite frame 904 and may respond to the first AP 102-a with a CBF Confirm frame 906. The second AP 102-b may prefetch one or more client vectors 916 for CBF steering with the first AP 102-a and may indicate the client vectors 916 (e.g., a set of clients, one or more sets of clients) in the CBF Confirm frame 906. The first AP 102-a may receive the CBF Confirm frame 906 and may prefetch the one or more client vectors 916 based on the set of clients communicated in (e.g., indicated by) the CBF Confirm frame 906.

Conversely, in the signaling diagram 900-b, the first AP 102-a may be a shared AP 102, and the second AP 102-b may be a sharing AP 102. That is, in the signaling diagram 900-b, the second AP 102-b may be an owner of the shared TXOP 902, and the first AP 102-a may share the shared TXOP 502 with the second AP 102-b. The owner of the shared TXOP 902 (e.g., the second AP 102-b) may initiate a CBF procedure by transmitting a CBF Invite frame 904 (e.g., to the first AP 102-a). The first AP 102-a may receive the CBF Invite frame 904 and may respond to the second AP 102-b with a CBF Confirm frame 906. The first AP 102-a may prefetch one or more client vectors 916 for CBF steering with the second AP 102-b and may indicate the client vectors 916 (e.g., a set of clients, one or more sets of clients) in the CBF Confirm frame 906. The second AP 102-b may receive the CBF Confirm frame 906 and may prefetch the one or more client vectors 916 based on the set of clients communicated in (e.g., indicated by) the CBF Confirm frame 906.

After communication (e.g., transmission, reception) of the CBF Confirm frame 906, the first AP 102-a (e.g., the sharing AP 102) may transmit a CBF Trigger frame 908 to the second AP 102-b to initiate data transmissions from both the first AP 102-a and the second AP 102-b via the shared TXOP 902. In the example of FIG. 9, the first AP 102-a may transmit the CBF Trigger frame 908 regardless of which AP (e.g., the first AP 102-a or the second AP 102-b) initiated the CBF procedure by transmitting the CBF Invite frame 904. The second AP 102-b may receive the CBF Trigger frame 908 and may use the CBF Trigger frame 908 as a frequency reference frame for estimating a CFO between the first AP 102-a and the second AP 102-b.

After communication of the CBF Trigger frame 908, both the first AP 102-a and the second AP 102-b may transmit a CBF transmission 910 to a respective STA 104. For example, the first AP 102-a may transmit a first CBF transmission 910-a to the first STA 104-a, and the second AP 102-b may transmit a second CBF transmission 910-b to the second STA 104-b. Additionally, after transmitting the first CBF transmission 910-a to the first STA 104-a, the first AP 102-a may transmit a first multi-user block acknowledgement request (MU-BAR) frame 912-a to the first STA 104-a. Responsive to receiving the first MU-BAR frame 912-a, the first STA 104-a may transmit a first BA frame 914-a to the first AP 102-a. Similarly, after transmitting the second CBF transmission 910-b to the second STA 104-b, the second AP 102-b may transmit a second MU-BAR frame 912-b to the second STA 104-b. Responsive to receiving the second MU-BAR frame 912-b, the second STA 104-b may transmit a second BA frame 914-b to the second AP 102-b. In some cases, the second AP 102-b may wait to transmit the second MU-BAR frame 912-b until after the first AP 102-a receives the first BA frame 914-a from the first STA 104-a.

To transmit the second CBF transmission 910-b to the second STA 104-b during the shared TXOP 902, the second AP 102-b may perform CFO alignment and correct for a CFO between the first AP 102-a and the second AP 102-b. By doing this, the first CBF transmission 910-a and the second CBF transmission 910-b may be aligned in frequency with respect to the first AP 102-a (e.g., the frequency reference). In some examples, the second AP 102-b may perform CFO alignment during the transmission phase using the CBF Trigger frame 908 transmitted by the first AP 102-a. After estimating the CFO, the second AP 102-b may pre-compensate for the CFO before transmitting the second CBF transmission 910-b to the second STA 104-b.

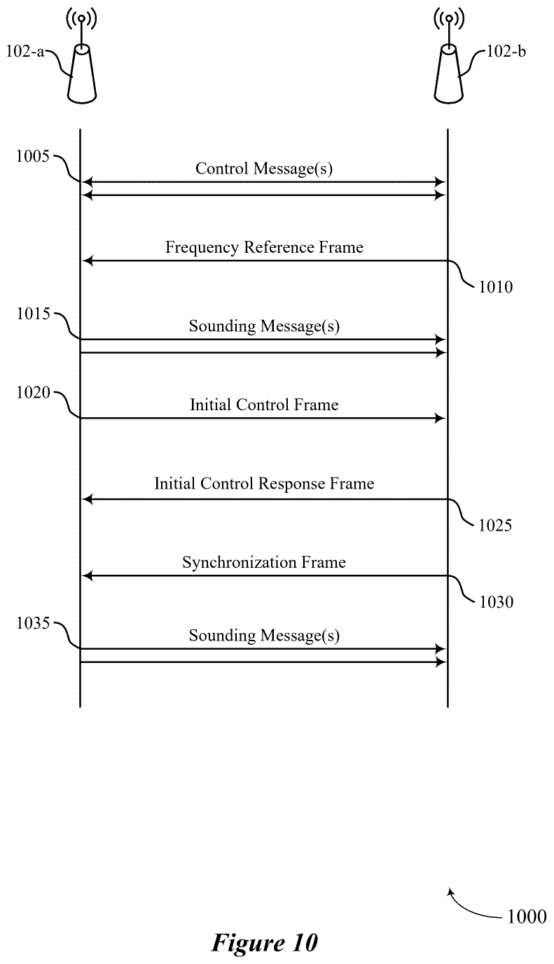

FIG. 10 shows an example of a process flow 1000 that supports CFO compensation between access points for CBF sounding and transmission. The process flow 1000 may implement or be implemented by aspects of the wireless communication network 100, the signaling diagram 200, the signaling diagram 300, the signaling diagram 400, or any combination thereof, as described with reference to FIG. 1-3.

For example, the process flow 1000 may illustrate actions performed by a first AP 102-a and a second AP 102-b, which may be examples of corresponding devices as described herein, including with reference to FIG. 1-3. In the following description of the process flow 1000, the operations between the first AP 102-a and the second AP 102-b may be performed in a different order than the example shown, or the operations between the first AP 102-a and the second AP 102-b may be performed in different orders at different times. Some operations may also be omitted from the process flow 1000, and other operations may be added to the process flow 1000.

At 1005, the first AP 102-a may communicate one or more control messages with the second AP 102-b to trigger a CBF sounding procedure by the first AP 102-a and the second AP 102-b, the one or more control messages indicating that the second AP 102-b is to operate as a carrier frequency alignment reference for messaging of the CBF sounding procedure. In some cases, the one or more control messages may indicate whether additional CBF sounding procedures are performed sequentially or simultaneously by the first AP 102-a and the second AP 102-b.

In some examples, communicating the one or more control messages may include receiving a first control message of the one or more control messages indicating that the second AP 102-b is operating as the carrier frequency alignment reference. In some other examples, communicating the one or more control messages may include transmitting the first control message of the one or more control messages indicating that the second AP 102-b is to operate as the carrier frequency alignment reference. In such examples, after transmitting the first control message, the first AP 102-a may receive a second control message of the one or more control messages confirming receipt of the first control message.

At 1010, the first AP 102-a may receive a frequency reference frame from the second AP 102-b. In some examples, the frequency reference frame may be an NDPA frame. At 1015, the first AP 102-a may transmit one or more sounding messages of the CBF sounding procedure based on a CFO estimated from the frequency reference frame.

In other some examples, the frequency reference frame may be an NDPA frame. In such examples, at 1020, the first AP 102-a may transmit an ICF to the second AP 102-b for a second CBF sounding procedure. At 1025, the first AP 102-a may receive an ICR frame that acts as a second frequency reference frame from the second AP 102-b for the second CBF sounding procedure. Additionally, or alternatively, at 1030, the first AP 102-a may receive a synchronization frame that acts as the second frequency reference frame from the second AP 102-b for a second CBF sounding procedure. For example, in some cases the ICR frame may be the synchronization frame. At 1035, the first AP 102-a may transmit one or more sounding messages of the second CBF sounding procedure based on the synchronization frame. In some examples, the first AP 102-a may transmit the one or more sounding messages of the second CBF sounding procedure based on a CFO estimated from the ICR frame, synchronization frame, or both.

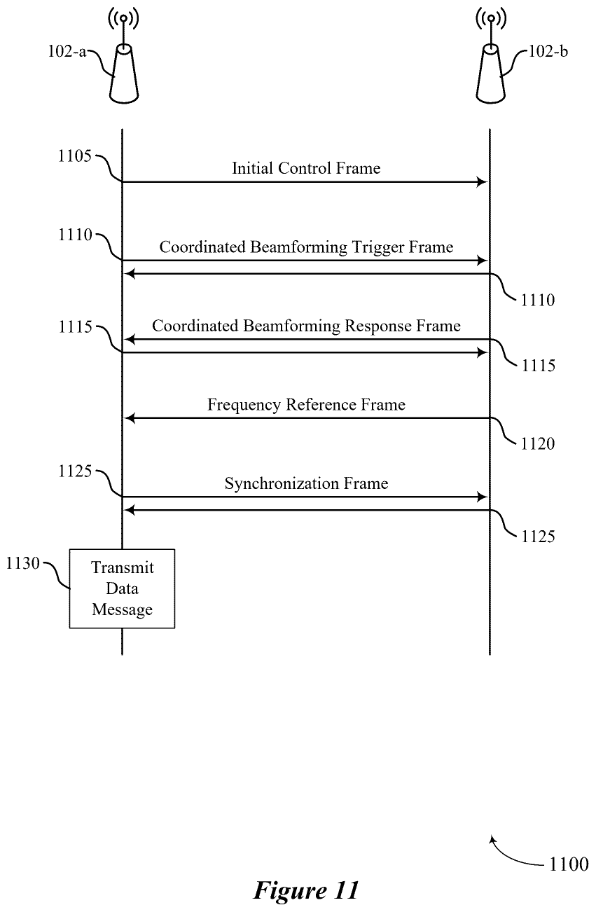

FIG. 11 shows an example of a process flow 1100 that supports CFO compensation between access points for CBF sounding and transmission. The process flow 1100 may implement or be implemented by aspects of the wireless communication network 100, the signaling diagram 200, the signaling diagram 500, the signaling diagram 600, the signaling diagram 700, the signaling diagram 800, or any combination thereof, as described with reference to FIGS. 1, 2, and 5-8. For example, the process flow 1100 may illustrate actions performed by a first AP 102-a and a second AP 102-b, which may be examples of corresponding devices as described herein, including with reference to FIGS. 1, 2, and 5-8. In the following description of the process flow 1100, the operations between the first AP 102-a and the second AP 102-b may be performed in a different order than the example shown, or the operations between the first AP 102-a and the second AP 102-b may be performed in different orders at different times. Some operations may also be omitted from the process flow 1100, and other operations may be added to the process flow 1100.

At 1105, the first AP 102-a may transmit an ICF to the second AP 102-b during the TXOP. In such cases, the first AP 102-a may receive a frequency reference frame based on the ICF. For example, the frequency reference frame may be an ICR frame transmitted by the second AP 102-b responsive to the ICF. Alternatively, the first AP 102-a may receive an ICR frame separate from the frequency reference frame. For example, the frequency reference frame may be a CBF response frame. In some examples, at 1110, the first AP 102-a may transmit a CBF trigger frame to the second AP 102-b during the TXOP and may receive the CBF response frame based on the CBF trigger frame. For example, at 1115, the first AP 102-a may receive the CBF response frame based on the CBF trigger frame.

In some other examples, the ICF may request for the second AP 102-b to initiate a CBF transmission sequence. In such cases, at 1110, the first AP 102-a may receive a CBF trigger frame from the second AP 102-b during the TXOP based on the ICF. At 1115, the first AP 102-a may transmit the CBF response frame to the second AP 102-b based on a CFO (e.g., estimated from the CBF trigger frame). In such examples, the frequency reference frame may be a synchronization frame received based on the CBF response frame.

At 1120, the first AP 102-a may receive the frequency reference frame from a second AP during a TXOP of a shared wireless channel. In some examples, the first AP 102-a may be an owner of the TXOP for a transmission phase of a CBF sounding procedure. Alternatively, the first AP 102-a may receive the frequency reference frame during a channel sounding phase of a CBF sounding procedure.

In some examples, at 1125, the first AP 102-a may transmit a synchronization frame to the second AP 102-b during the TXOP. In some other examples, the first AP 102-a may receive the synchronization frame from the second AP 102-b during the TXOP, where the synchronization frame acts as the frequency reference frame. In some cases, the first AP 102-a may receive the synchronization frame based on the CBF response frame.

At 1130, the first AP 102-a may transmit, to one or more STAs associated with the first AP 102-a during the transmission phase of the CBF sounding procedure, a data message during the TXOP based at least in part on a CFO estimated from the frequency reference frame, from the synchronization frame, or both. The data message may be based on the synchronization frame and may include one or more downlink PPDUs. Alternatively, in examples where the first AP 102-a receives the frequency reference frame during the channel sounding phase of the CBF sounding procedure, the one or more transmissions during the transmission phase of the CBF sounding procedure may be based on the CFO estimated from the frequency reference frame received during the channel sounding phase of the CBF sounding procedure.

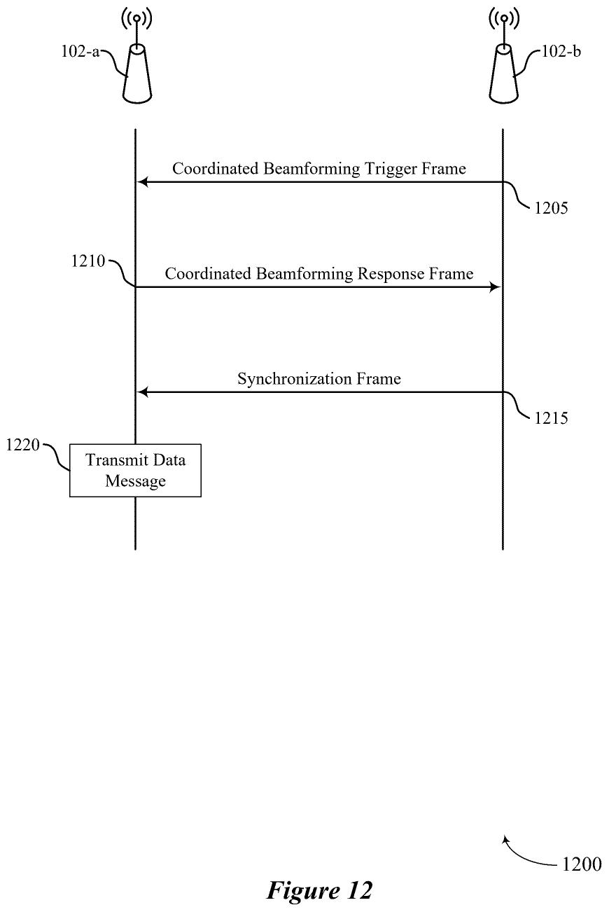

FIG. 12 shows an example of a process flow 1200 that supports CFO compensation between access points for CBF sounding and transmission. The process flow 1200 may implement or be implemented by aspects of the wireless communication network 100, the signaling diagram 200, the signaling diagram 500, or any combination thereof, as described with reference to FIGS. 1, 2, and 5. For example, the process flow 1200 may illustrate actions performed by a first AP 102-a and a second AP 102-b, which may be examples of corresponding devices as described herein, including with reference to FIGS. 1, 2, and 5. In the following description of the process flow 1200, the operations between the first AP 102-a and the second AP 102-b may be performed in a different order than the example shown, or the operations between the first AP 102-a and the second AP 102-b may be performed in different orders at different times. Some operations may also be omitted from the process flow 1200, and other operations may be added to the process flow 1200.

At 1205, the first AP 102-a may receive a CBF trigger frame from the second AP 102-b during a TXOP of a shared wireless channel. In some examples, the CBF trigger frame may indicate that the second AP 102-b is an owner of the TXOP. At 1210, the first AP 102-a may transmit, to the second AP 102-b, a CBF response frame during the TXOP based on the CBF trigger frame.

At 1215, the first AP 102-a may receive a synchronization frame from the second AP 102-b during the TXOP based on the CBF response frame. At 1220, the first AP 102-a may transmit, to one or more STAs associated with the first AP 102-a during a transmission phase of a CBF sounding procedure, a data message during the TXOP based on a CFO estimated from the synchronization frame. In some examples, the data message may include one or more downlink PPDUs.

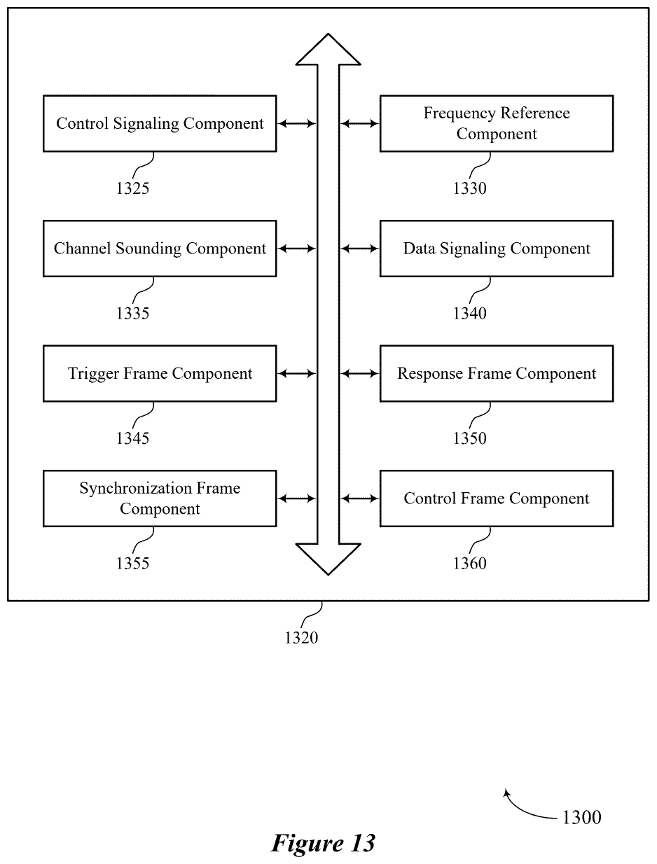

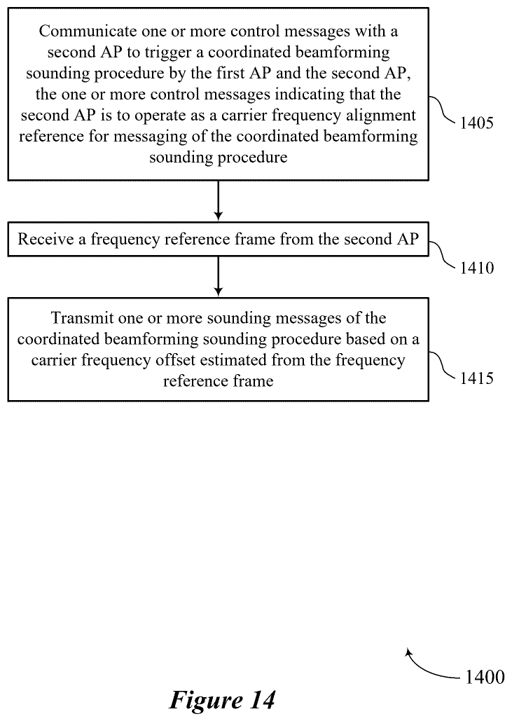

FIG. 13 shows a block diagram 1300 of an example wireless communication device 1320 that supports CFO compensation between access points for CBF sounding and transmission. In some examples, the wireless communication device 1320 is configured to perform the processes 1400, 1500, and 1600 described with reference to FIGS. 14, 15, and 16, respectively. The wireless communication device 1320 may include one or more chips, SoCs, chipsets, packages, components or devices that individually or collectively constitute or include a processing system. The processing system may interface with other components of the wireless communication device 1320, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1320 may transmit the information output from the chip. In such an example, the second interface may refer to an interface between the processing system of the chip and a reception component, such that the wireless communication device 1320 may receive information that is then passed to the processing system. In some such examples, the first interface also may obtain information, such as from the transmission component, and the second interface also may output information, such as to the reception component.

The processing system of the wireless communication device 1320 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1320 can be configurable or configured for use in an AP, such as the AP 102 described with reference to FIG. 1. In some other examples, the wireless communication device 1320 can be an AP that includes such a processing system and other components including multiple antennas. The wireless communication device 1320 is capable of transmitting and receiving wireless communications in the form of, for example, wireless packets. For example, the wireless communication device 1320 can be configurable or configured to transmit and receive packets in the form of physical layer PPDUs and MPDUs conforming to one or more of the IEEE 802.11 family of wireless communication protocol standards. In some other examples, the wireless communication device 1320 can be configurable or configured to transmit and receive signals and communications conforming to one or more 3GPP specifications including those for 5G NR or 6G. In some examples, the wireless communication device 1320 also includes or can be coupled with one or more application processors which may be further coupled with one or more other memories. In some examples, the wireless communication device 1320 further includes at least one external network interface coupled with the processing system that enables communication with a core network or backhaul network that enables the wireless communication device 1320 to gain access to external networks including the Internet.

The wireless communication device 1320 includes a control signaling component 1325, a frequency reference component 1330, a channel sounding component 1335, a data signaling component 1340, a trigger frame component 1345, a response frame component 1350, a synchronization frame component 1355, and a control frame component 1360. Portions of one or more of the control signaling component 1325, the frequency reference component 1330, the channel sounding component 1335, the data signaling component 1340, the trigger frame component 1345, the response frame component 1350, the synchronization frame component 1355, and the control frame component 1360 may be implemented at least in part in hardware or firmware. For example, one or more of the control signaling component 1325, the frequency reference component 1330, the channel sounding component 1335, the data signaling component 1340, the trigger frame component 1345, the response frame component 1350, the synchronization frame component 1355, and the control frame component 1360 may be implemented at least in part by at least a processor or a modem. In some examples, portions of one or more of the control signaling component 1325, the frequency reference component 1330, the channel sounding component 1335, the data signaling component 1340, the trigger frame component 1345, the response frame component 1350, the synchronization frame component 1355, and the control frame component 1360 may be implemented at least in part by a processor and software in the form of processor-executable code stored in memory.

The wireless communication device 1320 may support wireless communications in accordance with examples as disclosed herein. The control signaling component 1325 is configurable or configured to communicate one or more control messages with a second AP to trigger a CBF sounding procedure by the first AP and the second AP, the one or more control messages indicating that the second AP is to operate as a carrier frequency alignment reference for messaging of the CBF sounding procedure. The frequency reference component 1330 is configurable or configured to receive a frequency reference frame from the second AP. The channel sounding component 1335 is configurable or configured to transmit one or more sounding messages of the CBF sounding procedure based on a CFO estimated from the frequency reference frame.

In some examples, the synchronization frame component 1355 is configurable or configured to receive a synchronization frame that acts as a second frequency reference frame from the second AP for a second CBF sounding procedure. In some examples, the channel sounding component 1335 is configurable or configured to transmit one or more sounding messages of the second CBF sounding procedure based on the synchronization frame. In some examples, the control frame component 1360 is configurable or configured to transmit an ICF to the second AP for a second CBF sounding procedure. In some examples, the response frame component 1350 is configurable or configured to receive an ICR frame that acts as a second frequency reference frame from the second AP for the second CBF sounding procedure. In some examples, channel sounding component 1335 is configurable or configured to transmit one or more sounding messages of the second CBF sounding procedure based on a second CFO estimated from the ICR frame.

In some examples, the one or more control messages indicate whether additional CBF sounding procedures are performed sequentially or simultaneously by the first AP and the second AP.

In some examples, the frequency reference frame is a null data packet announcement frame.

In some examples, to support communicating the one or more control messages, the control signaling component 1325 is configurable or configured to receive a first control message of the one or more control messages indicating that the second AP is operating as the carrier frequency alignment reference.

In some examples, to support communicating the one or more control messages, the control signaling component 1325 is configurable or configured to transmit a first control message of the one or more control messages indicating that the second AP is to operate as the carrier frequency alignment reference. In some examples, to support communicating one or more control messages, the control signaling component 1325 is configurable or configured to receive a second control message of the one or more control messages confirming receipt of the first control message.

Additionally, or alternatively, the wireless communication device 1320 may support wireless communications in accordance with examples as disclosed herein. In some examples, the frequency reference component 1330 is configurable or configured to receive a frequency reference frame from a second AP during a TXOP of a shared wireless channel, where the first AP is an owner of the TXOP for a transmission phase of a CBF sounding procedure. The data signaling component 1340 is configurable or configured to transmit, to one or more stations associated with the first AP during the transmission phase of the CBF sounding procedure, a data message during the TXOP based on a CFO estimated from the frequency reference frame.

In some examples, the synchronization frame component 1355 is configurable or configured to transmit a synchronization frame to the second AP during the TXOP, where the data message is transmitted based on the synchronization frame.

In some examples, the trigger frame component 1345 is configurable or configured to transmit a CBF trigger frame to the second AP during the TXOP, where the frequency reference frame is received based on the CBF trigger frame.

In some examples, the frequency reference frame is a CBF response frame.

In some examples, the control frame component 1360 is configurable or configured to transmit an initial control frame to the second AP during the TXOP, where the frequency reference frame is received based on the initial control frame.

In some examples, the frequency reference frame is an initial control response frame.

In some examples, the frequency reference frame is received during a channel sounding phase of the CBF sounding procedure. In some examples, one or more transmissions during the transmission phase of the CBF sounding procedure are based on the CFO estimated from the frequency reference frame received during the channel sounding phase of the CBF sounding procedure.

In some examples, the control frame component 1360 is configurable or configured to transmit an initial control frame to the second AP during the TXOP. In some examples, the trigger frame component 1345 is configurable or configured to receive a CBF trigger frame from the second AP during the TXOP based on the initial control frame. In some examples, the response frame component 1350 is configurable or configured to transmit a CBF response frame to the second AP based on the CBF trigger frame. In some examples, the synchronization frame component 1355 is configurable or configured to receive a synchronization frame comprising the frequency reference frame. In some examples, the data signaling component 1340 is configurable or configured to transmit, to the one or more stations associated with the first AP during the transmission phase of the CBF sounding procedure, the data message during the TXOP based on a CFO estimated from the frequency reference frame.

In some examples, the trigger frame component 1345 is configurable or configured to transmit a CBF trigger frame to the second AP during the TXOP. In some examples, the response frame component 1350 is configurable or configured to receive a CBF response frame from the second AP during the TXOP based on the CBF trigger frame. In some examples, the synchronization frame component 1355 is configurable or configured to receive a synchronization frame comprising the frequency reference frame based on the CBF response frame. In some examples, the data signaling component 1340 is configurable or configured to transmit, to the one or more stations associated with the first AP during the transmission phase of the CBF sounding procedure, the data message during the TXOP based on a CFO estimated from the synchronization frame In some examples, the data message includes one or more downlink PPDUs.

Additionally, or alternatively, the wireless communication device 1320 may support wireless communications in accordance with examples as disclosed herein. The trigger frame component 1345 is configurable or configured to receive a CBF trigger frame from a second AP during a TXOP of a shared wireless channel, where the CBF trigger frame indicates that the second AP is an owner of the TXOP. The response frame component 1350 is configurable or configured to transmit, to the second AP, a CBF response frame during the TXOP based on the CBF trigger frame. The synchronization frame component 1355 is configurable or configured to receive a synchronization frame from the second AP during the TXOP based on the CBF response frame. In some examples, the data signaling component 1340 is configurable or configured to transmit, to one or more stations associated with the first AP during a transmission phase of a CBF sounding procedure, a data message during the TXOP based on a CFO estimated from the synchronization frame.

In some examples, the data message includes one or more downlink PPDUs.

FIG. 14 shows a flowchart illustrating an example process 1400 performable by or at a first AP that supports CFO compensation between access points for CBF sounding and transmission. The operations of the process 1400 may be implemented by a first AP or its components as described herein. For example, the process 1400 may be performed by a wireless communication device, such as the wireless communication device 1320 described with reference to FIG. 13, operating as or within a wireless AP. In some examples, the process 1400 may be performed by a wireless AP, such as one of the APs 102 described with reference to FIG. 1.

In some examples, in 1405, the first AP may communicate one or more control messages with a second AP to trigger a CBF sounding procedure by the first AP and the second AP, the one or more control messages indicating that the second AP is to operate as a carrier frequency alignment reference for messaging of the CBF sounding procedure. The operations of 1405 may be performed in accordance with examples as disclosed herein. In some implementations, aspects of the operations of 1405 may be performed by a control signaling component 1325 as described with reference to FIG. 13.

In some examples, in 1410, the first AP may receive a frequency reference frame from the second AP. The operations of 1410 may be performed in accordance with examples as disclosed herein. In some implementations, aspects of the operations of 1410 may be performed by a frequency reference component 1330 as described with reference to FIG. 13.

In some examples, in 1415, the first AP may transmit one or more sounding messages of the CBF sounding procedure based on a CFO estimated from the frequency reference frame. The operations of 1415 may be performed in accordance with examples as disclosed herein. In some implementations, aspects of the operations of 1415 may be performed by a channel sounding component 1335 as described with reference to FIG. 13.

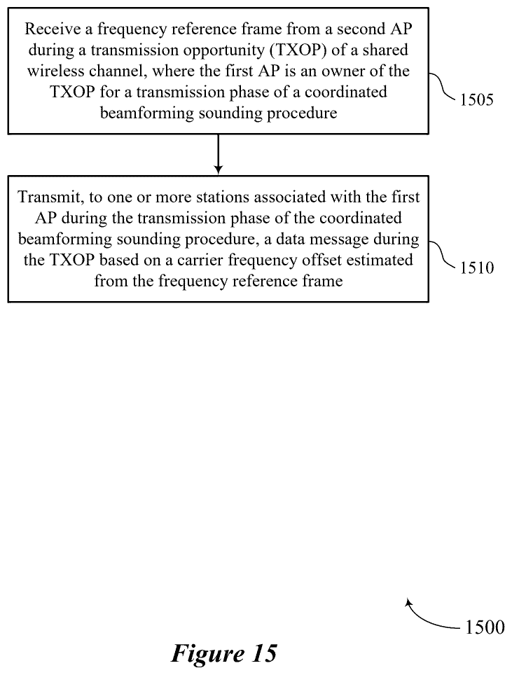

FIG. 15 shows a flowchart illustrating an example process 1500 performable by or at a first AP that supports CFO compensation between access points for CBF sounding and transmission. The operations of the process 1500 may be implemented by a first AP or its components as described herein. For example, the process 1500 may be performed by a wireless communication device, such as the wireless communication device 1320 described with reference to FIG. 13, operating as or within a wireless AP. In some examples, the process 1500 may be performed by a wireless AP, such as one of the APs 102 described with reference to FIG. 1.

In some examples, in 1505, the first AP may receive a frequency reference frame from a second AP during a TXOP of a shared wireless channel, where the first AP is an owner of the TXOP for a transmission phase of a CBF sounding procedure.

The operations of 1505 may be performed in accordance with examples as disclosed herein. In some implementations, aspects of the operations of 1505 may be performed by a frequency reference component 1330 as described with reference to FIG. 13.

In some examples, in 1510, the first AP may transmit, to one or more stations associated with the first AP during the transmission phase of the CBF sounding procedure, a data message during the TXOP based on a CFO estimated from the frequency reference frame. The operations of 1510 may be performed in accordance with examples as disclosed herein. In some implementations, aspects of the operations of 1510 may be performed by a data signaling component 1340 as described with reference to FIG. 13.

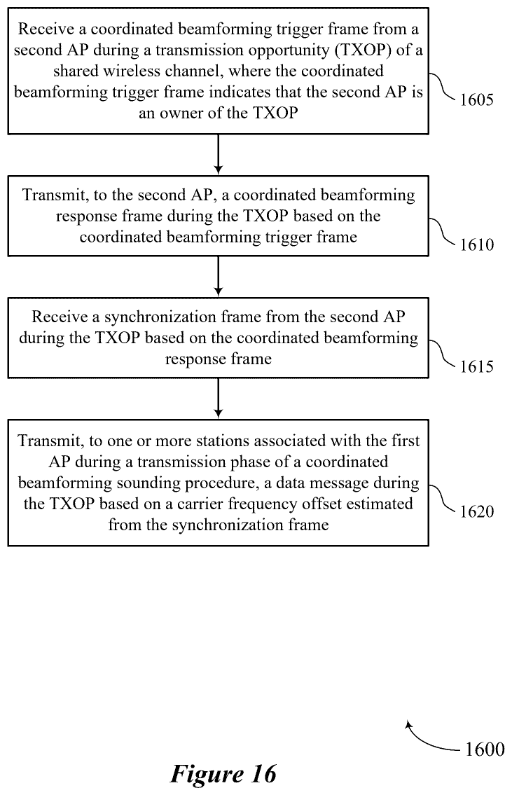

FIG. 16 shows a flowchart illustrating an example process 1600 performable by or at a first AP that supports CFO compensation between access points for CBF sounding and transmission. The operations of the process 1600 may be implemented by a first AP or its components as described herein. For example, the process 1600 may be performed by a wireless communication device, such as the wireless communication device 1320 described with reference to FIG. 13, operating as or within a wireless AP. In some examples, the process 1600 may be performed by a wireless AP, such as one of the APs 102 described with reference to FIG. 1.

In some examples, in 1605, the first AP may receive a CBF trigger frame from a second AP during a TXOP of a shared wireless channel, where the CBF trigger frame indicates that the second AP is an owner of the TXOP. The operations of 1605 may be performed in accordance with examples as disclosed herein. In some implementations, aspects of the operations of 1605 may be performed by a trigger frame component 1345 as described with reference to FIG. 13.

In some examples, in 1610, the first AP may transmit, to the second AP, a CBF response frame during the TXOP based on the CBF trigger frame. The operations of 1610 may be performed in accordance with examples as disclosed herein. In some implementations, aspects of the operations of 1610 may be performed by a response frame component 1350 as described with reference to FIG. 13.

In some examples, in 1615, the first AP may receive a synchronization frame from the second AP during the TXOP based on the CBF response frame. The operations of 1615 may be performed in accordance with examples as disclosed herein. In some implementations, aspects of the operations of 1615 may be performed by a synchronization frame component 1355 as described with reference to FIG. 13.

In some examples, in 1620, the first AP may transmit, to one or more stations associated with the first AP during a transmission phase of a CBF sounding procedure, a data message during the TXOP based on a CFO estimated from the synchronization frame. The operations of 1620 may be performed in accordance with examples as disclosed herein. In some implementations, aspects of the operations of 1620 may be performed by a data signaling component 1340 as described with reference to FIG. 13.

Implementation examples are described in the following numbered clauses:

Aspect 1: A method for wireless communications at a first AP, comprising: communicating one or more control messages with a second AP to trigger a CBF sounding procedure by the first AP and the second AP, the one or more control messages indicating that the second AP is to operate as a carrier frequency alignment reference for messaging of the CBF sounding procedure; receiving a frequency reference frame from the second AP; and transmitting one or more sounding messages of the CBF sounding procedure based at least in part on a CFO estimated from the frequency reference frame.

Aspect 2: The method of aspect 1, further comprising: receiving a synchronization frame that acts as a second frequency reference frame from the second AP for a second CBF sounding procedure; and transmitting one or more sounding messages of the second CBF sounding procedure based at least in part on the synchronization frame.

Aspect 3: The method of aspect 1, further comprising: transmitting an ICF to the second AP for a second CBF sounding procedure; receiving an ICR frame that acts as a second frequency reference frame from the second AP for the second CBF sounding procedure; and transmit one or more sounding messages of the second CBF sounding procedure based at least in part on a second CFO estimated from the ICR frame.

Aspect 4: The method of any of aspects 1 through 3, wherein the one or more control messages indicate whether additional CBF sounding procedures are performed sequentially or simultaneously by the first AP and the second AP.

Aspect 5: The method of any of aspects 1 through 4, wherein the frequency reference frame is a NDPA frame.

Aspect 6: The method of any of aspects 1 through 5, wherein communicating the one or more control messages further comprises: receiving a first control message of the one or more control messages indicating that the second AP is operating as the carrier frequency alignment reference.

Aspect 7: The method of any of aspects 1 through 6, wherein communicating the one or more control messages further comprises: transmitting a first control message of the one or more control messages indicating that the second AP is to operate as the carrier frequency alignment reference; and receiving a second control message of the one or more control messages confirming receipt of the first control message.

Aspect 8: A method for wireless communications at a first AP, comprising: receiving a frequency reference frame from a second AP during a TXOP of a shared wireless channel, wherein the first AP is an owner of the TXOP for a transmission phase of a CBF sounding procedure; and transmitting, to one or more stations associated with the first AP during the transmission phase of the CBF sounding procedure, a data message during the TXOP based at least in part on a CFO estimated from the frequency reference frame.

Aspect 9: The method of aspect 8, further comprising: transmitting a synchronization frame to the second AP during the TXOP, wherein the data message is transmitted based at least in part on the synchronization frame.

Aspect 10: The method of any of aspects 8 through 9, further comprising: transmitting a CBF trigger frame to the second AP during the TXOP, wherein the frequency reference frame is received based at least in part on the CBF trigger frame.

Aspect 11: The method of aspect 10, wherein the frequency reference frame is a CBF response frame.

Aspect 12: The method of any of aspects 10 through 11, wherein the data message comprises one or more downlink PPDUs.

Aspect 13: The method of aspect 8, further comprising: transmitting an ICF to the second AP during the TXOP, wherein the frequency reference frame is received based at least in part on the ICF.

Aspect 14: The method of aspect 13, wherein the frequency reference frame is an ICR frame.

Aspect 15: The method of aspect 8, wherein the frequency reference frame is received during a channel sounding phase of the CBF sounding procedure, and one or more transmissions during the transmission phase of the CBF sounding procedure are based at least in part on the CFO estimated from the frequency reference frame received during the channel sounding phase of the CBF sounding procedure.

Aspect 16: The method of aspect 8, further comprising: transmitting an ICF to the second AP during the TXOP; receiving a CBF trigger frame from the second AP during the TXOP based at least in part on the ICF; transmitting a CBF response frame to the second AP based at least in part on the CBF trigger frame; receiving a synchronization frame comprising the frequency reference frame; and transmitting, to the one or more stations associated with the first AP, the data message during the TXOP based at least in part on a CFO estimated from the synchronization frame.

Aspect 17: The method of aspect 8, further comprising: transmitting an CBF trigger frame to the second AP during the TXOP; receiving a CBF response frame from the second AP during the TXOP based at least in part on the CBF trigger frame; receiving a synchronization frame comprising the frequency reference frame based at least in part on the CBF response frame; and transmitting, to the one or more stations associated with the first AP, the data message during the TXOP based at least in part on a CFO estimated from the synchronization frame.

Aspect 18: A method for wireless communications at a first AP, comprising: receiving a CBF trigger frame from a second AP during a TXOP of a shared wireless channel, wherein the CBF trigger frame indicates that the second AP is an owner of the TXOP; transmitting, to the second AP, a CBF response frame during the TXOP based at least in part on the CBF trigger frame; receiving a synchronization frame from the second AP during the TXOP based at least in part on the CBF response frame; and transmitting, to one or more stations associated with the first AP during a transmission phase of a CBF sounding procedure, a data message during the TXOP based at least in part on a CFO estimated from the synchronization frame.

Aspect 19: The method of aspect 18, wherein the data message comprises one or more downlink PPDUs.

Aspect 20: A first AP for wireless communications, comprising one or more memories storing processor-executable code, and one or more processors coupled with the one or more memories and individually or collectively operable to execute the code to cause the first AP to perform a method of any of aspects 1 through 7.

Aspect 21: A first AP for wireless communications, comprising at least one means for performing a method of any of aspects 1 through 7.

Aspect 22: A non-transitory computer-readable medium storing code for wireless communications, the code comprising instructions executable by one or more processors to perform a method of any of aspects 1 through 7.

Aspect 23: A first AP for wireless communications, comprising one or more memories storing processor-executable code, and one or more processors coupled with the one or more memories and individually or collectively operable to execute the code to cause the first AP to perform a method of any of aspects 8 through 17.

Aspect 24: A first AP for wireless communications, comprising at least one means for performing a method of any of aspects 8 through 17.

Aspect 25: A non-transitory computer-readable medium storing code for wireless communications, the code comprising instructions executable by one or more processors to perform a method of any of aspects 8 through 17.

Aspect 26: A first AP for wireless communications, comprising one or more memories storing processor-executable code, and one or more processors coupled with the one or more memories and individually or collectively operable to execute the code to cause the first AP to perform a method of any of aspects 18 through 19.

Aspect 27: A first AP for wireless communications, comprising at least one means for performing a method of any of aspects 18 through 19.

Aspect 28: A non-transitory computer-readable medium storing code for wireless communications, the code comprising instructions executable by one or more processors to perform a method of any of aspects 18 through 19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a, ’” or the equivalent in context, whatever it is that is “based on ‘a, ’” or “based at least in part on ‘a, ’” may be based on “a” alone or based on a combination of “a”and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
communicate one or more control messages with a second AP to trigger a coordinated beamforming sounding procedure by the first AP and the second AP, the one or more control messages indicating that the second AP is to operate as a carrier frequency alignment reference for messaging of the coordinated beamforming sounding procedure;
receive a frequency reference frame from the second AP; and
transmit one or more sounding messages of the coordinated beamforming sounding procedure based at least in part on a carrier frequency offset estimated from the frequency reference frame.

2. The first AP of claim 1, wherein the processing system is further configured to cause the first AP to:
receive a synchronization frame that acts as a second frequency reference frame from the second AP for a second coordinated beamforming sounding procedure; and
transmit one or more sounding messages of the second coordinated beamforming sounding procedure based at least in part on the synchronization frame.

3. The first AP of claim 1, wherein the processing system is further configured to cause the first AP to:
transmit an initial control frame to the second AP for a second coordinated beamforming sounding procedure;
receive an initial control response frame that acts as a second frequency reference frame from the second AP for the second coordinated beamforming sounding procedure; and
transmit one or more sounding messages of the second coordinated beamforming sounding procedure based at least in part on a second carrier frequency offset estimated from the initial control response frame.

4. The first AP of claim 1, wherein the one or more control messages indicate whether additional coordinated beamforming sounding procedures are performed sequentially or simultaneously by the first AP and the second AP.

5. The first AP of claim 1, wherein the frequency reference frame is a null data packet announcement frame.

6. The first AP of claim 1, wherein, to communicate the one or more control messages, the processing system is further configured to cause the first AP to:
receive a first control message of the one or more control messages indicating that the second AP is operating as the carrier frequency alignment reference.

7. The first AP of claim 1, wherein, to communicate the one or more control messages, the processing system is further configured to cause the first AP to:
transmit a first control message of the one or more control messages indicating that the second AP is to operate as the carrier frequency alignment reference; and
receive a second control message of the one or more control messages confirming receipt of the first control message.

8. A first access point (AP), comprising:
a processing system that includes processor circuitry and memory circuitry that stores code, the processing system configured to cause the first AP to:
receive a frequency reference frame from a second AP during a transmission opportunity (TXOP) of a shared wireless channel, wherein the first AP is an owner of the TXOP for a transmission phase of a coordinated beamforming sounding procedure; and
transmit, to one or more stations associated with the first AP during the transmission phase of the coordinated beamforming sounding procedure, a data message during the TXOP based at least in part on a carrier frequency offset estimated from the frequency reference frame.

9. The first AP of claim 8, wherein the processing system is further configured to cause the first AP to:
transmit a synchronization frame to the second AP during the TXOP, wherein the data message is transmitted based at least in part on the synchronization frame.

10. The first AP of claim 8, wherein the processing system is further configured to cause the first AP to:
transmit a coordinated beamforming trigger frame to the second AP during the TXOP, wherein the frequency reference frame is received based at least in part on the coordinated beamforming trigger frame.

11. The first AP of claim 10, wherein the frequency reference frame is a coordinated beamforming response frame.

12. The first AP of claim 8, wherein the processing system is further configured to cause the first AP to:
transmit an initial control frame to the second AP during the TXOP, wherein the frequency reference frame is received based at least in part on the initial control frame.

13. The first AP of claim 12, wherein the frequency reference frame is an initial control response frame.

14. The first AP of claim 8, wherein:
the frequency reference frame is received during a channel sounding phase of the coordinated beamforming sounding procedure, and
one or more transmissions during the transmission phase of the coordinated beamforming sounding procedure are based at least in part on the carrier frequency offset estimated from the frequency reference frame received during the channel sounding phase of the coordinated beamforming sounding procedure.

15. The first AP of claim 8, wherein the processing system is further configured to cause the first AP to:
transmit an initial control frame to the second AP during the TXOP;
receive a coordinated beamforming trigger frame from the second AP during the TXOP based at least in part on the initial control frame;
transmit a coordinated beamforming response frame to the second AP based at least in part on the coordinated beamforming trigger frame;
receive a synchronization frame comprising the frequency reference frame; and
transmit, to the one or more stations associated with the first AP, the data message during the TXOP based at least in part on a carrier frequency offset estimated from the synchronization frame.

16. The first AP of claim 8, wherein the processing system is further configured to cause the first AP to:
transmit a coordinated beamforming trigger frame to the second AP during the TXOP;
receive a coordinated beamforming response frame from the second AP during the TXOP based at least in part on the coordinated beamforming trigger frame;
receive a synchronization frame comprising the frequency reference frame based at least in part on the coordinated beamforming response frame; and
transmit, to the one or more stations associated with the first AP, the data message during the TXOP based at least in part on a carrier frequency offset estimated from the synchronization frame.

17. The first AP of claim 8, wherein:
the data message comprises one or more downlink physical protocol data units.

18. A first access point (AP), comprising:
a processing system that includes processor circuitry and memory circuitry that stores code, the processing system configured to cause the first AP to:
receive a coordinated beamforming trigger frame from a second AP during a transmission opportunity (TXOP) of a shared wireless channel, wherein the coordinated beamforming trigger frame indicates that the second AP is an owner of the TXOP;
transmit, to the second AP, a coordinated beamforming response frame during the TXOP based at least in part on the coordinated beamforming trigger frame;
receive a synchronization frame from the second AP during the TXOP based at least in part on the coordinated beamforming response frame; and
transmit, to one or more stations associated with the first AP during a transmission phase of a coordinated beamforming sounding procedure, a data message during the TXOP based at least in part on a carrier frequency offset estimated from the synchronization frame.

19. The first access point (AP) of claim 18, wherein:
the data message comprises one or more downlink physical protocol data units.

20. A method for wireless communications at a first access point (AP), comprising:
receiving a frequency reference frame from a second AP during a transmission opportunity (TXOP) of a shared wireless channel, wherein the first AP is an owner of the TXOP for a transmission phase of a coordinated beamforming sounding procedure; and
transmitting, to one or more stations associated with the first AP during the transmission phase of the coordinated beamforming sounding procedure, a data message during the TXOP based at least in part on a carrier frequency offset estimated from the frequency reference frame.

21. The method of claim 20, further comprising:
transmitting a synchronization frame to the second AP during the TXOP, wherein the data message is transmitted based at least in part on the synchronization frame.

22. The method of claim 20, further comprising:
transmitting a coordinated beamforming trigger frame to the second AP during the TXOP, wherein the frequency reference frame is received based at least in part on the coordinated beamforming trigger frame.

23. The method of claim 22, wherein the frequency reference frame is a coordinated beamforming response frame.

24. The method of claim 20, further comprising:
transmitting an initial control frame to the second AP during the TXOP, wherein the frequency reference frame is received based at least in part on the initial control frame.

25. The method of claim 24, wherein the frequency reference frame is an initial control response frame.

26. The method of claim 20, wherein:
the frequency reference frame is received during a channel sounding phase of the coordinated beamforming sounding procedure, and
one or more transmissions during the transmission phase of the coordinated beamforming sounding procedure are based at least in part on the carrier frequency offset estimated from the frequency reference frame received during the channel sounding phase of the coordinated beamforming sounding procedure.

27. The method of claim 20, further comprising:
transmitting an initial control frame to the second AP during the TXOP;
receiving a coordinated beamforming trigger frame from the second AP during the TXOP based at least in part on the initial control frame;
transmitting a coordinated beamforming response frame to the second AP based at least in part on the coordinated beamforming trigger frame;
receiving a synchronization frame comprising the frequency reference frame; and
transmitting, to the one or more stations associated with the first AP, the data message during the TXOP based at least in part on a carrier frequency offset estimated from the synchronization frame.

28. The method of claim 20, further comprising:
transmitting a coordinated beamforming trigger frame to the second AP during the TXOP;
receiving a coordinated beamforming response frame from the second AP during the TXOP based at least in part on the coordinated beamforming trigger frame;
receiving a synchronization frame comprising the frequency reference frame based at least in part on the coordinated beamforming response frame; and
transmitting, to the one or more stations associated with the first AP, the data message during the TXOP based at least in part on a carrier frequency offset estimated from the synchronization frame.

29. The method of claim 20, wherein the data message comprises one or more downlink physical protocol data units.
